(19) United States
(12) Patent Application Publication
(10) Pub. No.: US 2022/0239832 A1
(43) Pub. Date: Jul. 28, 2022

(54) Image Processing as a Function of Deformable Electronic Device Geometry and Corresponding Devices and Methods

(71) Applicant: Motorola Mobility LLC, Chicago, IL (US)

(72) Inventors: Vivek Tyagi, Chicago, IL (US); Chao Ma, Evanston, IL (US); Joseph Nasti, Chicago, IL (US); Kevin Dao, Skokie, IL (US); Nikhil Ambha Madhusudhana, Chicago, IL (US)

(21) Appl. No.: 17/161,573

(22) Filed: Jan. 28, 2021

(51) Int. Cl. H04N 5/232; H04N 5/225; H04N 13/128; H04N 13/156

(52) U.S. Cl. CPC H04N 5/23238; H04N 5/2258; H04N 2013/0088; H04N 13/128; H04N 13/156; H04N 5/2252

(57) ABSTRACT

An electronic device includes one or more sensors detecting a geometry of the electronic device. At least one imager, disposed to a first side of a deformable portion of the electronic device, captures at least one image while at least one other imager, disposed to a second side of the deformable portion of the electronic device, captures at least one other image. The at least one image and at least one other image can each be any of a single image, a sequence of images, or video. One or more processors combine the at least one image and the at least one other image to create a composite image as a function of the geometry of the electronic device.

### BACKGROUND

### Technical Field

This disclosure relates generally to electronic devices, and more particularly to deformable electronic devices having imagers.

### Background Art

The feature sets included with modern portable electronic devices, such as smartphones, tablet computers, smart watches, and other devices, are increasingly becoming richer and more sophisticated. Illustrating by example, while mobile phones were once equipped with simplistic image capture devices capable of capturing only thumbnail images with marginal resolution, modern smartphones have image capture devices capable of capturing images and video with a quality level that rivals even professional grade studio equipment. Entire television shows, and even feature length movies, have been shot using only a smartphone.

Owners of these devices are increasingly using their image capture devices to create unique video content, be it for personal consumption only, distribution via social media, or for other purposes. New attachments, including camera dongles that have a 360-degree view, are expanding the feature sets offered by on-board image capture devices. However, such attachments are cumbersome to attach, can be damaged while attached, and can be lost when unattached. It would be advantageous to have improved methods and electronic devices that allow for a richer image capture experience without the need for external attachments or additional gadgetry.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory deformable electronic device in accordance with one or more embodiments of the disclosure.

FIG. 2 illustrates a sectional view of one explanatory deformable electronic device in accordance with one or more embodiments of the disclosure.

FIG. 3 illustrates a user manipulating one explanatory deformable electronic device in accordance with one or more embodiments of the disclosure to execute a bending operation to deform the explanatory electronic device.

FIG. 4 illustrates one explanatory deformable electronic device being deformed by one or more bends in accordance with one or more embodiments of the disclosure.

FIG. 5 illustrates one explanatory deformable electronic device deformed by one or more bends in accordance with one or more embodiments of the disclosure.

FIG. 6 illustrates another explanatory deformable electronic device in accordance with one or more embodiments of the disclosure with the deformable electronic device in an undeformed state.

FIG. 7 illustrates a first perspective view of the explanatory deformable electronic device of FIG. 6 in a deformed state in accordance with one or more embodiments of the disclosure.

FIG. 8 illustrates a second perspective view of the explanatory deformable electronic device of FIG. 6 in a deformed state in accordance with one or more embodiments of the disclosure.

FIG. 9 illustrates a side elevation view of the explanatory deformable electronic device of FIG. 6 in the deformed state in accordance with one or more embodiments of the disclosure.

FIG. 10 illustrates one explanatory method in accordance with one or more embodiments of the disclosure.

FIG. 11 illustrates one explanatory image processing mode occurring as a function of the geometry of a deformable electronic device in accordance with one or more embodiments of the disclosure.

FIG. 12 illustrates another explanatory image processing mode occurring as a function of the geometry of a deformable electronic device in accordance with one or more embodiments of the disclosure.

FIG. 13 illustrates yet another explanatory image processing mode occurring as a function of the geometry of a deformable electronic device in accordance with one or more embodiments of the disclosure.

FIG. 14 illustrates still another explanatory image processing mode occurring as a function of the geometry of a deformable electronic device in accordance with one or more embodiments of the disclosure.

FIG. 15 illustrates another explanatory image processing mode occurring as a function of the geometry of a deformable electronic device in accordance with one or more embodiments of the disclosure.

FIG. 16 illustrates one or more explanatory method steps for processing at least two images in a deformable electronic device having at least two imagers in accordance with one or more embodiments of the disclosure.

FIG. 17 illustrates one or more explanatory method steps for processing at least two images in a deformable electronic device having at least two imagers in accordance with one or more embodiments of the disclosure.

FIG. 18 illustrates one or more explanatory method steps for processing at least two images in a deformable electronic device having at least two imagers in accordance with one or more embodiments of the disclosure.

FIG. 19 illustrates one or more explanatory method steps for processing at least two images in a deformable electronic device having at least two imagers in accordance with one or more embodiments of the disclosure.

FIG. 20 illustrates one or more explanatory method steps for processing at least two images in a deformable electronic device having at least two imagers in accordance with one or more embodiments of the disclosure.

FIG. 21 illustrates one or more explanatory method steps for processing at least two images in a deformable electronic device having at least two imagers in accordance with one or more embodiments of the disclosure.

FIG. 22 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting a geometry of a deformable electronic device having at least two imagers and processing at least two images as a function of the geometry of the deformable electronic device. Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of processing, synthesizing, and/or combining at least one image and at least one other image captured by at least one imager and at least one imager of a deformable electronic device as a function of the geometry of that deformable electronic device as described herein. While many of the examples below will be directed to single image operations for simplicity, it should be understood that the processing, synthesizing, and/or combining operations could be equally applied to sequences of images, video, or other multi-image constructs as well. Additionally, the non-processor circuits may include, but are not limited to, image sensors, lenses, image processing circuits and processors, signal drivers, clock circuits, power source circuits, and user input devices. As such, these functions may be interpreted as steps of a method to perform the processing, synthesis, and/or combining of at least two images as a function of a geometry of a deformable electronic device and/or angle of a bend in a deformable electronic device.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. The terms “imager” and “image capture device” each refer to electronic devices having sensors for receiving light, optionally through a lens, and rendering electronically captured images depicting a field of view.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide methods and electronic devices that detect, using one or more sensors of the electronic device, a geometry of a deformable electronic device having at least two imagers. At least one imager captures at least one image, while at least one other imager captures at least one other image. One or more processors then process the at least one image and the at least one other image as a function of the geometry of the deformable electronic device. As noted above, while many of the examples below will be directed to single image operations for simplicity, it should be understood that the same examples could equally be applied to sequences of images, video, or other multi-image constructs as well. Accordingly, “at least one image” and “at least one other image” will be understood to encompass a single image a sequence of images, or video.

Illustrating by example, when the deformable electronic device defines a bend, with at least one imager situated on a first device housing portion positioned to a first side of the bend and at least one other imager situated on a second device housing portion positioned to the second side of the bend, embodiments of the disclosure contemplate that the field of view of the at least one imager and the at least one other imager will either converge or diverge depending upon the angle of the bend. This convergence or divergence can be used to expand the field of view of a single imager. Accordingly, once the angle of the bend is known, in one or more embodiments one or more processors can process the at least one image and the at least one other image as a function of this angle of the bend to create new, exciting, and otherwise unattainable images in a seamless and user-friendly manner.

If, for instance, the first device housing portion abuts the second device housing portion such that the field of view of one imager is oriented in a direction substantially opposite that of another field of view of another imager, in one or more embodiments the one or more sensors can detect this geometry, with the one or more processors thereafter processing the two images to create a panoramic image. Alternatively, in other embodiments the one or more processors can superimpose at least a portion of the first image on at least a portion of the other image to create a composite image having a wider field of view.

Similarly, if the first device housing portion is oriented substantially orthogonally with the second device housing portion such that the field of view of one imager is oriented substantially orthogonally with another field of view of another imagers, in one or more embodiments the one or more sensors can detect this geometry with the one or more processors then processing a first image captured by one imager and a second image captured by a second imager to superimpose at least a portion of the first image upon at least a portion of the second image to create a composite image.

If the first device housing portion and the second device housing portion define a non-orthogonal angle where the fields of view of the imagers converge or diverge, in one or more embodiments the one or more processors can superimpose at least a portion of one image on at least a portion of another image to create a composite image. If the first device housing portion and the second device housing portion define a plane without any bend occurring in the electronic device, the one or more processors can synthesize the first image and the second image to create a stereo image, a depth map, or a double image in one or more embodiments, and so forth.

Embodiments of the disclosure also contemplate that the ability to capture 360-degree images and video is emerging as a next generation content creation and consumption format in portable electronic devices. This content creation format is becoming more important for consumers, advertisers, social media companies. Additionally, embodiments of the disclosure contemplate that this image capture format is important during videoconferencing as content creators participating in videoconferences are generally looking for new and interesting features that allow them to more deftly express their creativity.

However, the necessity of carrying around an extra dongle capable of capturing 360-degree images is cumbersome and troublesome, as they need to be attached before panoramic images can be captured, can be lost, and can be bumped and damaged when attached to an electronic device. Moreover, with such combinations the content creator is left with two distinct operating modes—either the dongle is attached to the electronic device and all images are 360-degree images, or the dongle is unattached from the electronic device and no images are 360-degree images. In sum, these attachable dongles offer no mechanism for dynamically switching between panoramic and non-panoramic views.

Embodiments of the disclosure offer solutions to these problems with by providing uniquely new electronic devices that are deformable and include multiple imagers. For example, in one or more embodiments a deformable electronic device comprises a first image capture device and a second image capture device situated under a foldable display. In one or more embodiments, when the electronic device deforms, the foldable display deforms outward, thereby extending about the exterior of a convex angle defined by the bending of the electronic device.

In one or more embodiments, one or more processors provide a high-level logical image processing system for each image capture device. In one or more embodiments, the one or more processors are capable of processing images captured by the two (or more) image capture devices as a function of the geometry, e.g., degrees of bend defined by angle between first device housing portion and second device housing portion, whether the first device housing portion and second device housing portion abut, and so forth, to stitch, merge, concatenate, superimpose, and perform other processing steps upon the content streams being captured by each image capture device. By understanding the geometry of the electronic device occurring when images are captured, embodiments of the disclosure allow users to seamlessly and instantly create a variety of composite image types. Examples include combined “selfie” images with expanded fields of view, extreme wide-angle images, fusion images, multi-user videoconferencing images, front/rear fusion images concatenating images from opposite sides of the electronic device, panoramic images, fusion front and back camera view depicting a user and scene, fusion videoconferencing views where participants see each other and what the other person sees, fusion front and back views showing two users on each side of the electronic device, extending views from each imager to create a semi-panoramic composite image, and dual camera video logging views that allow for creative movie making. Other composite image types will be described below. Still others will be obvious to those of ordinary skill in the art having the benefit of this disclosure.

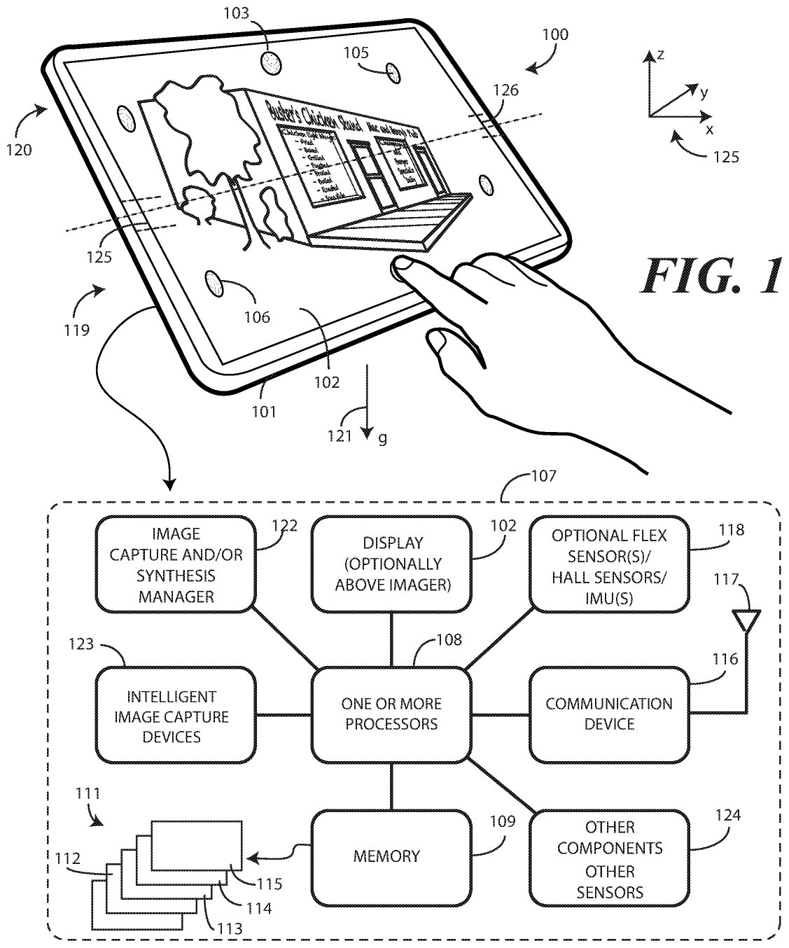

Turning now to FIG. 1, illustrated therein is one explanatory electronic device 100 configured in accordance with one or more embodiments of the disclosure. The electronic device 100 of FIG. 1 is a portable electronic device. This illustrative electronic device 100 includes a display 102, which is touch-sensitive. The display 102 can serve as a primary user interface of the electronic device 100. Users can deliver user input to the display 102 of such an embodiment by delivering touch input from a finger, stylus, or other objects disposed proximately with the display.

In one embodiment, the display 102 is configured as an organic light emitting diode (OLED) display fabricated on a flexible plastic substrate. However, it should be noted that other types of displays would be obvious to those of ordinary skill in the art having the benefit of this disclosure. In one or more embodiments, an OLED is constructed on flexible plastic substrates can allow the display 102 to become flexible in one or more embodiments with various bending radii. For example, some embodiments allow bending radii of between thirty and six hundred millimeters to provide a bendable display. Other substrates allow bending radii of around five millimeters to provide a display that is foldable through active bending. Other displays can be configured to accommodate both bends and folds. In one or more embodiments the display 102 may be formed from multiple layers of flexible material such as flexible sheets of polymer or other materials. While the display 102 of FIG. 1 is a flexible display, in other embodiments one or more rigid displays could be placed across a major face of the electronic device 100 and used in tandem to define a display assembly. Other configurations for the display 102 will be obvious to those of ordinary skill in the art having the benefit of this disclosure.

The explanatory electronic device 100 of FIG. 1 also includes a housing 101 supporting the display 102. In one or more embodiments, the housing 101 is flexible. In one embodiment, the housing 101 may be manufactured from a malleable, bendable, or physically deformable material such as a flexible thermoplastic, flexible composite material, flexible fiber material, flexible metal, organic or inorganic textile or polymer material, or other materials.

In other embodiments, the housing 101 could also be a combination of rigid segments connected by hinges 125,126 or flexible materials. For instance, the electronic device 100 could alternatively include a first device housing and a second device housing with a hinge coupling the first device housing to the second device housing such that the first device housing is selectively pivotable about the hinge relative to the second device housing. The first device housing can be selectively pivotable about the hinge between a closed position, a partially open position, and an axially displaced open position.

In other embodiments, the housing 101 could be a composite of multiple components. For instance, in another embodiment the housing 101 could be a combination of rigid segments connected by hinges or flexible materials. Still other constructs will be obvious to those of ordinary skill in the art having the benefit of this disclosure.

Where the housing 101 is a deformable housing, it can be manufactured from a single flexible housing member or from multiple flexible housing members. In this illustrative embodiment, a user interface component 103, which may be a button or touch sensitive surface, can also be disposed along the housing 101 to facilitate control of the electronic device 100. In the illustrative embodiment of FIG. 1, the user interface component 103 comprises a fingerprint sensor positioned under the display 102 of the electronic device 100. In other embodiments, the user interface component 103 will be placed to the side of the display 102, rather than beneath the display 102.

Other features can be added and can be located on the front of the housing 101, sides of the housing 101, or the rear of the housing 101. Illustrating by example, in one or more embodiments a first image capture device 105 can be disposed on one side of the electronic device 100, while a second image capture device 106 is disposed on another side of the electronic device 100. In the illustrative embodiment of FIG. 1, each of the first image capture device 105 and the second energy capture device 106 is positioned beneath the display 102. However, in other embodiments, the first image capture device 105 and the second image capture device 106 could be placed beside the display 102, rather than beneath the display 102.

A block diagram schematic 107 of the electronic device 100 is also shown in FIG. 1. In one or more embodiments, the block diagram schematic 107 is configured as a printed circuit board assembly disposed within the device housing 101. Various components can be electrically coupled together by conductors or a bus disposed along one or more printed circuit boards, which can optionally be flexible circuit boards or alternatively rigid circuit boards coupled together by one or more flexible conductors or substrates. It should be noted that the block diagram schematic 107 includes many components that are optional, but which are included in an effort to demonstrate how varied electronic devices configured in accordance with embodiments of the disclosure can be.

Thus, it is to be understood that the block diagram schematic 107 of FIG. 1 is provided for illustrative purposes only and for illustrating components of one electronic device 100 in accordance with embodiments of the disclosure. The block diagram schematic 107 of FIG. 1 is not intended to be a complete schematic diagram of the various components required for an electronic device 100. Therefore, other electronic devices in accordance with embodiments of the disclosure may include various other components not shown in FIG. 1 or may include a combination of two or more components or a division of a particular component into two or more separate components, and still be within the scope of the present disclosure.

In one embodiment, the electronic device 100 includes one or more processors 108. The one or more processors 108 can be a microprocessor, a group of processing components, one or more Application Specific Integrated Circuits (ASICs), programmable logic, or other type of processing device. The one or more processors 108 can be operable with the various components of the electronic device 100. The one or more processors 108 can be configured to process and execute executable software code to perform the various functions of the electronic device 100. A storage device, such as memory 109, can optionally store the executable software code used by the one or more processors 108 during operation.

In one or more embodiments when the electronic device 100 is deformed by a bend at a deformable portion 110 of the electronic device 100, this results in at least one imager, e.g., image capture device 106, being disposed to a first side of the deformable portion 110 of the electronic device 100, while at least one other imager, e.g., image capture device 105, is disposed to a second side of the deformable portion 110 of the electronic device 100. In one or more embodiments, the at least one imager captures at least one image while being positioned on the first side of the deformable portion 110, and the at least one other imager captures at least one other image while being positioned on the second side of the deformable portion 110.

In one or more embodiments, the one or more processors 108 can then combine the at least one image and the at least one other image to create a composite image. In one or more embodiments, the way in which the one or more processors 108 combine the at least one image and the at least one other image occurs as a function of the geometry of the electronic device 100. Illustrating by example, in one or more embodiments the way in which the one or more processors 108 combine the at least one image and the at least one other image occurs as a function of an angle of a bend occurring at the deformable portion 110 of the electronic device 100.

In one or more embodiments, the one or more processors 108 are further responsible for performing the primary functions of the electronic device 100. For example, in one embodiment the one or more processors 108 comprise one or more circuits operable to present presentation information, such as images, text, and video, on the display 102. The executable software code used by the one or more processors 108 can be configured as one or more modules 111 that are operable with the one or more processors 108. Such modules 111 can store instructions, control algorithms, and so forth.

In one embodiment, the one or more processors 108 are responsible for running the operating system environment 112. The operating system environment 112 can include a kernel, one or more drivers 113, and an application service layer 114, and an application layer 115. The operating system environment 112 can be configured as executable code operating on one or more processors or control circuits of the electronic device 100.

In one or more embodiments, the one or more processors 108 are responsible for managing the applications of the electronic device 100. In one or more embodiments, the one or more processors 108 are also responsible for launching, monitoring and killing the various applications and the various application service modules. The applications of the application layer 115 can be configured as clients of the application service layer 114 to communicate with services through application program interfaces (APIs), messages, events, or other inter-process communication interfaces.

In this illustrative embodiment, the electronic device 100 also includes a communication circuit 116 that can be configured for wired or wireless communication with one or more other devices or networks. The networks can include a wide area network, a local area network, and/or personal area network. The communication circuit 116 may also utilize wireless technology for communication, such as, but are not limited to, peer-to-peer or ad hoc communications, and other forms of wireless communication such as infrared technology. The communication circuit 116 can include wireless communication circuitry, one of a receiver, a transmitter, or transceiver, and one or more antennas 117.

In one embodiment, the electronic device 100 includes one or more sensors 118 operable to determine a geometry of the electronic device 100. Illustrating by example, in one or more embodiments the one or more sensors 118 operable to detect the geometry of the electronic device 100 detect angles between a first device housing portion 119 and a second device housing portion 120 separated from the first device housing portion 119 by the deformable portion 110 of the electronic device 100. The one or more sensors 118 operable to determine a geometry of the electronic device 100 can detect the first device housing portion 119 pivoting, bending, or deforming about the deformable portion 110 relative to the second device housing portion 120. The one or more sensors 118 operable to determine the geometry can take various forms.

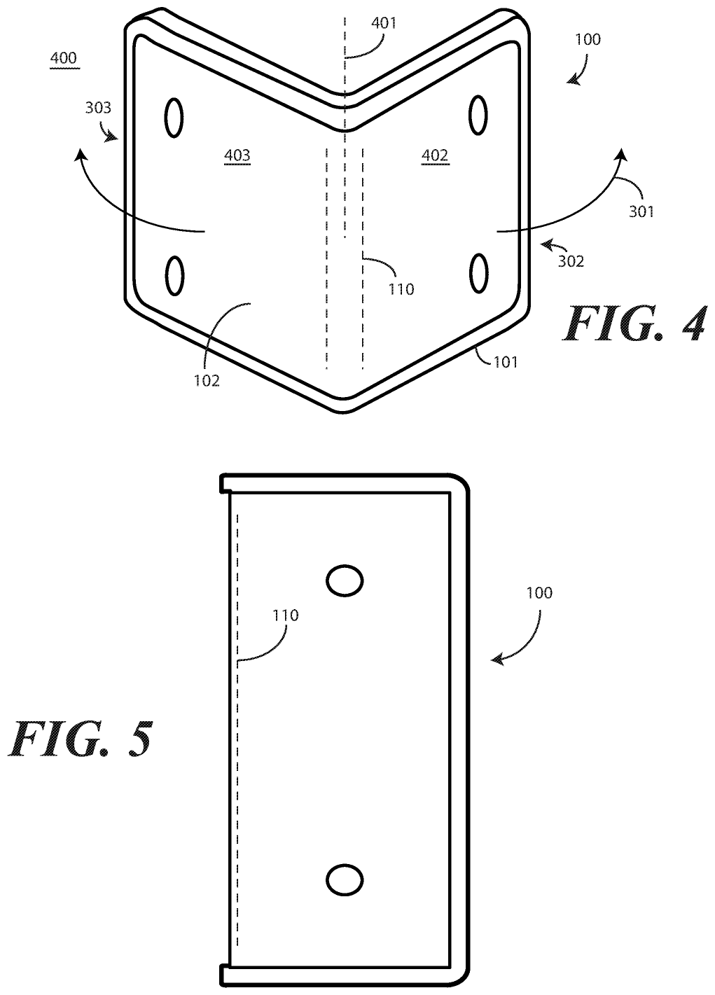

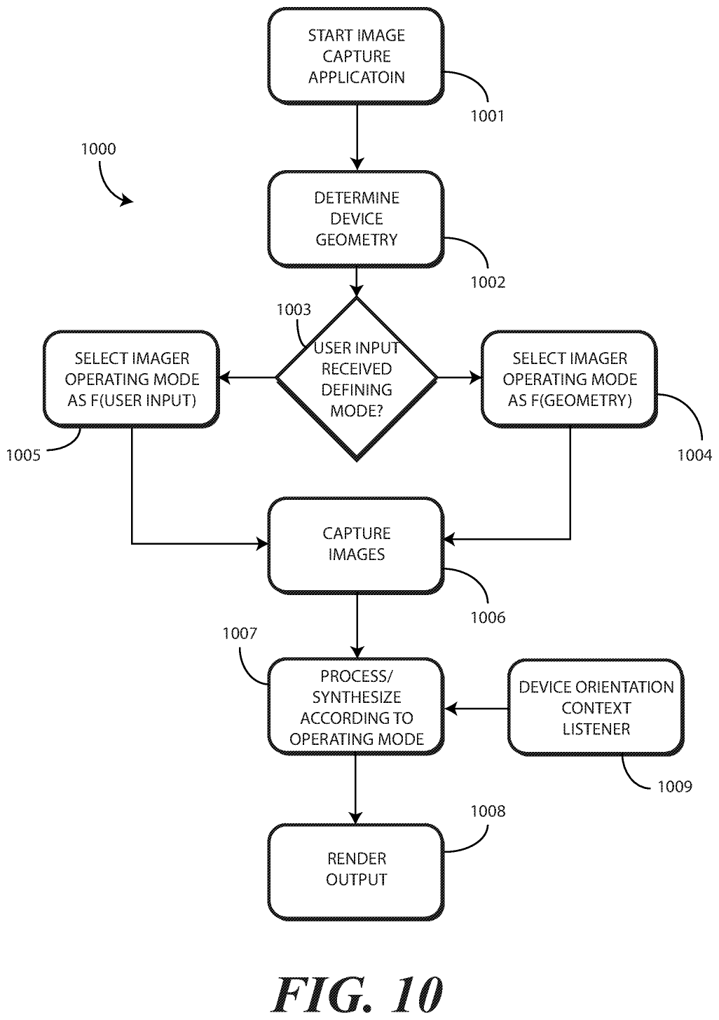

In one or more embodiments, the one or more sensors 118 operable to determine the geometry of the electronic device 100 comprise one or more flex sensors supported by the housing 101 and operable with the one or more processors 108 to detect a bending operation deforming one or more of the housing 101 or the display 102 into a deformed geometry, such as that shown in FIGS. 4, 5, and 7-9. The inclusion of flex sensors is optional, and in some embodiment flex sensors will not be included. As one or more image processing functions of the electronic device 100 occur as a function of the geometry of the electronic device 100 when deformed, where flex sensors are not included, the user can optionally alert the one or more processors 108 to the fact that the one or more bends are present through the user interface or by other techniques.

Where included, in one embodiment the flex sensors each comprise passive resistive devices manufactured from a material with an impedance that changes when the material is bent, deformed, or flexed. By detecting changes in the impedance as a function of resistance, the one or more processors 108 can use the one or more flex sensors to detect bending or flexing. In one or more embodiments, each flex sensor comprises a bi-directional flex sensor that can detect flexing or bending in two directions. In one embodiment, the one or more flex sensors have an impedance that increases in an amount that is proportional with the amount it is deformed or bent.

In one embodiment, each flex sensor is manufactured from a series of layers combined together in a stacked structure. In one embodiment, at least one layer is conductive, and is manufactured from a metal foil such as copper. A resistive material provides another layer. These layers can be adhesively coupled together in one or more embodiments. The resistive material can be manufactured from a variety of partially conductive materials, including paper-based materials, plastic-based materials, metallic materials, and textile-based materials. In one embodiment, a thermoplastic such as polyethylene can be impregnated with carbon or metal so as to be partially conductive, while at the same time being flexible.

In one embodiment, the resistive layer is sandwiched between two conductive layers. Electrical current flows into one conductive layer, through the resistive layer, and out of the other conductive layer. As the flex sensor bends, the impedance of the resistive layer changes, thereby altering the flow of current for a given voltage. The one or more processors 108 can detect this change to determine an amount of bending. Taps can be added along each flex sensor to determine other information, including the number of folds, the degree of each fold, the location of the folds, the direction of the folds, and so forth. The flex sensor can further be driven by time-varying signals to increase the amount of information obtained from the flex sensor as well.

While a multi-layered device as a flex sensor is one configuration suitable for detecting a bending operation occurring to deform the electronic device 100 and a geometry of the electronic device 100 after the bending operation, other sensors 118 for detecting the geometry of the electronic device 100 can be used as well. For instance, a magnet can be placed in the first device housing portion 119 while a magnetic sensor is placed in the second device housing portion 120, or vice versa. The magnetic sensor could be Hall-effect sensor, a giant magnetoresistance effect sensor, a tunnel magnetoresistance effect sensor, an anisotropic magnetoresistive sensor, or other type of sensor.

In still other embodiments, the one or more sensors 118 operable to determine a geometry of the electronic device 100 can comprise an inductive coil placed in the first device housing portion 119 and a piece of metal placed in the second device housing portion 120, or vice versa. When the metal is in close proximity to the coil, the one or more sensors 118 operable to determine a geometry of the electronic device 100 detect the first device housing portion 119 and the second device housing portion 120 in a first position. By contrast, when the metal is farther away from the coil, the one or more sensors 118 operable to determine a geometry of the electronic device 100 can detect the first device housing portion 119 and the second device housing portion 120 being in a second position, and so forth.

In other embodiments the one or more sensors 118 operable to determine a geometry of the electronic device 100 can comprise an inertial motion unit situated in the first device housing portion 119 and another inertial motion unit situated in the second device housing portion 120. The one or more processors 108 can compare motion sensor readings from each inertial motion unit to track the relative movement and/or position of the first device housing portion 119 relative to the second device housing portion 120, as well as the first device housing portion 119 and the second device housing portion 120 relative to the direction of gravity 121. This data can be used to determine and or track the state and position of the first device housing portion 119 and the second device housing portion 120 directly as they pivot about the deformable portion 110, as well as their orientation with reference to a direction of gravity 121.

Where included as the one or more sensors 118 operable to determine the geometry of the electronic device 100, each inertial motion unit can comprise a combination of one or more accelerometers, one or more gyroscopes, and optionally one or more magnetometers, to determine the orientation, angular velocity, and/or specific force of one or both of the first device housing portion 119 or the second device housing portion 120. When included in the electronic device 100, these inertial motion units can be used as orientation sensors to measure the orientation of one or both of the first device housing portion 119 or the second device housing portion 120 in three-dimensional space 125. Similarly, the inertial motion units can be used as orientation sensors to measure the motion of one or both of the first device housing portion 119 or second device housing portion 120 in three-dimensional space 125. The inertial motion units can be used to make other measurements as well.

Where only one inertial motion unit is included in the first device housing portion 119, this inertial motion unit is configured to determine an orientation, which can include measurements of azimuth, plumb, tilt, velocity, angular velocity, acceleration, and angular acceleration, of the first device housing portion 119. Similarly, where two inertial motion units are included, with one inertial motion unit being situated in the first device housing portion 119 and another inertial motion unit being situated in the second device housing portion 120, each inertial motion unit determines the orientation of its respective device housing. Inertial motion unit can determine measurements of azimuth, plumb, tilt, velocity, angular velocity, acceleration, angular acceleration, and so forth of the first device housing portion 119, while inertial motion unit can determine measurements of azimuth, plumb, tilt, velocity, angular velocity, acceleration, angular acceleration, and so forth of the second device housing portion 120, and so forth.

In one or more embodiments, each inertial motion unit delivers these orientation measurements to the one or more processors 108 in the form of orientation determination signals. Thus, the inertial motion unit situated in the first device housing portion 119 outputs a first orientation determination signal comprising the determined orientation of the first device housing portion 119, while the inertial motion unit situated in the second device housing portion 120 outputs another orientation determination signal comprising the determined orientation of the second device housing portion 120.

In one or more embodiments, the orientation determination signals are delivered to the one or more processors 108, which report the determined orientations to the various modules, components, and applications operating on the electronic device 100. In one or more embodiments, the one or more processors 108 can be configured to deliver a composite orientation that is an average or other combination of the orientation of orientation determination signals. In other embodiments, the one or more processors 108 are configured to deliver one or the other orientation determination signal to the various modules, components, and applications operating on the electronic device 100.

In another embodiment the one or more sensors 118 operable to determine a geometry of the electronic device 100 comprise proximity sensors that detect how far a first end of the electronic device 100 is from a second end of the electronic device 100. Still other examples of the one or more sensors 118 operable to determine a geometry of the electronic device 100 will be obvious to those of ordinary skill in the art having the benefit of this disclosure.

In one or more embodiments, the one or more sensors 118 operable to determine a geometry of the electronic device 100 can comprise an image capture analysis/synthesis manager 122. When the electronic device 100 defines a bend in the deformable portion 110, with image capture device 106 situated on the first device housing portion 119 positioned to a first side of the bend and image capture device 105 situated on the second device housing portion 120 positioned to the second side of the bend, the image capture analysis/synthesis manager 122 can detect that the field of view of image capture device 106 and the field of view of image capture device 105 converging or diverging depending upon the angle of the bend, and can determine the geometry by processing images from image capture device 106 and image capture device 105 to determine the angle of the bend.

If, for instance, the first device housing portion 119 abuts the second device housing portion 120 (see, e.g., FIGS. 5 and 7-9) such that the field of view of one imager is oriented in a direction substantially opposite that of another field of view of another imager, in one or more embodiments the image capture analysis/synthesis manager 122 can detect this fact by detecting that either neither field of view captures the same content, or if the fields of view are sufficiently wide, that only content in the periphery of each field of view is common between images captured by image capture device 105 and image capture device 106.

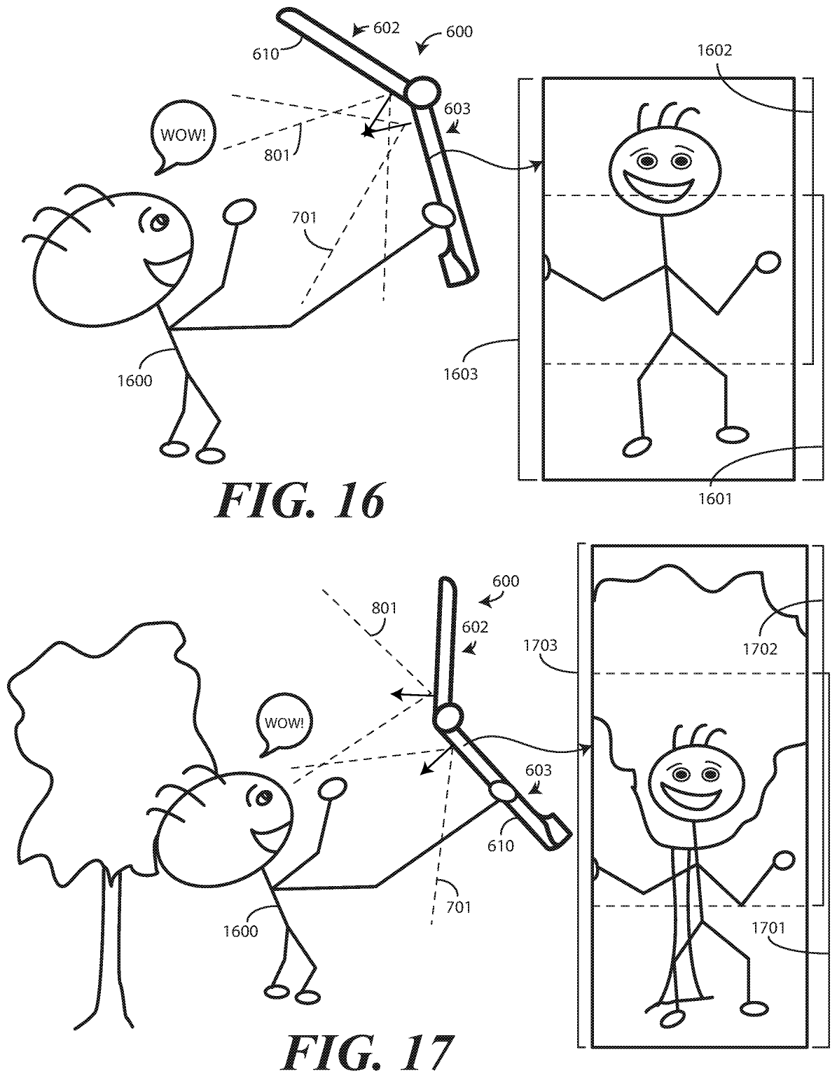

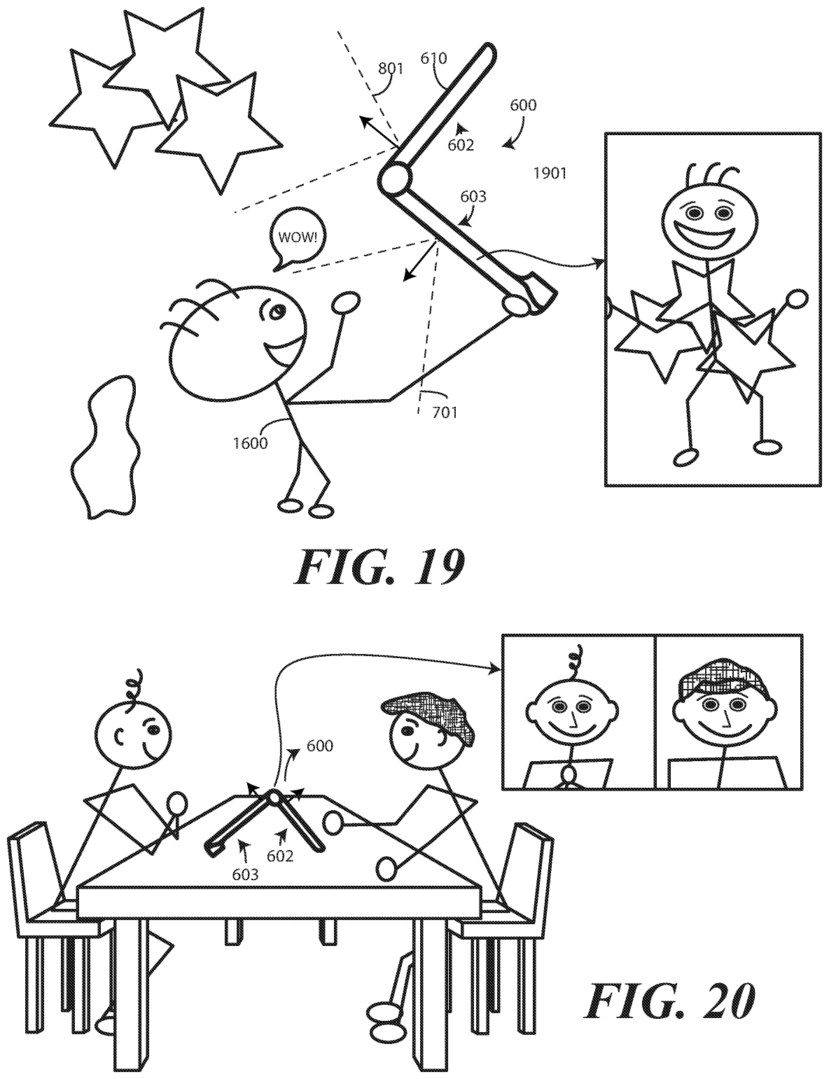

Similarly, if the first device housing portion 119 is oriented substantially orthogonally with the second device housing portion 120 such that the field of view of image capture device 105 is oriented substantially orthogonally with another field of view of image capture device 106, in one or more embodiments the image capture analysis/synthesis manager 122 can detect this geometry by detecting that either field of view captures the same content only at partial peripheries. If the first device housing portion 119 and the second device housing portion 120 define a non-orthogonal angle where the fields of view of the imagers converge (FIG. 16) or diverge (FIG. 19), in one or more embodiments image capture analysis/synthesis manager 122 can detect this by detecting expected amounts of overlap of the content visible in each field of view, and so forth. Still other types of the one or more sensors 118 operable to determine a geometry of the electronic device 100 will be obvious to those of ordinary skill in the art having the benefit of this disclosure.

In one or more embodiments, each of the first image capture device 105 and the second image capture device 106 comprises an intelligent imager 123. Where configured as an intelligent imager 123, each image capture device 105,106 can capture one or more images of environments about the electronic device 100 and determine whether the object matches predetermined criteria. For example, the intelligent imager 123 operate as an identification module configured with optical recognition such as include image recognition, character recognition, visual recognition, facial recognition, color recognition, shape recognition and the like. Advantageously, the intelligent imager 123 can recognize whether a user's face or eyes are disposed to a first side of the electronic device 100 when it is folded or to a second side. Similarly, the intelligent imager 123, in one embodiment, can detect whether the user is gazing toward a portion of the display 102 disposed to a first side of a bend or another portion of the display 102 disposed to a second side of a bend. In yet another embodiment, the intelligent imager 123 can determine where a user's eyes or face are located in three-dimensional space relative to the electronic device 100.

In addition to, or instead of the intelligent imager 123, one or more proximity sensors included with the other sensors and components 124 can determine to which side of the electronic device 100 the user is positioned when the electronic device 100 is deformed. The proximity sensors can include one or more proximity sensor components. The proximity sensors can also include one or more proximity detector components. In one embodiment, the proximity sensor components comprise only signal receivers. By contrast, the proximity detector components include a signal receiver and a corresponding signal transmitter.

While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments the proximity sensor components have a longer detection range than do the proximity detector components due to the fact that the proximity sensor components detect heat directly emanating from a person's body (as opposed to reflecting off the person's body) while the proximity detector components rely upon reflections of infrared light emitted from the signal transmitter. For example, the proximity sensor component may be able to detect a person's body heat from a distance of about ten feet, while the signal receiver of the proximity detector component may only be able to detect reflected signals from the transmitter at a distance of about one to two feet.

In one embodiment, the proximity sensor components comprise an infrared signal receiver so as to be able to detect infrared emissions from a person. Accordingly, the proximity sensor components require no transmitter since objects disposed external to the housing 101 of the electronic device 100 deliver emissions that are received by the infrared receiver. As no transmitter is required, each proximity sensor component can operate at a very low power level. Evaluations show that a group of infrared signal receivers can operate with a total current drain of just a few microamps (˜10 microamps per sensor). By contrast, a proximity detector component, which includes a signal transmitter, may draw hundreds of microamps to a few milliamps.

In one embodiment, one or more proximity detector components can each include a signal receiver and a corresponding signal transmitter. The signal transmitter can transmit a beam of infrared light that reflects from a nearby object and is received by a corresponding signal receiver. The proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

In one embodiment, the one or more processors 108 may generate commands or execute control operations based on information received from the various sensors and components 124, including the one or more sensors 118 operable to determine the geometry of the electronic device 100, the first image capture device 105, the second image capture device 106, or other components of the electronic device. The one or more processors 108 may also generate commands or execute control operations based upon information received from a combination of these components. Moreover, the one or more processors 108 may process the received information alone or in combination with other data, such as the information stored in the memory 109.

The other sensors and components 124 may include a microphone, an earpiece speaker, a loudspeaker, key selection sensors, a touch pad sensor, a touch screen sensor, a capacitive touch sensor, and one or more switches. Touch sensors may be used to indicate whether any of the user actuation targets present on the display 102 are being actuated. Alternatively, touch sensors disposed in the housing 101 can be used to determine whether the electronic device 100 is being touched at side edges or major faces of the electronic device 100 are being performed by a user. The touch sensors can include surface and/or housing capacitive sensors in one embodiment. The other sensors and components 124 can also include video sensors (such as a camera).

The other sensors and components 124 can also include motion detectors, such as one or more accelerometers or gyroscopes. For example, an accelerometer may be embedded in the electronic circuitry of the electronic device 100 to show vertical orientation, constant tilt and/or whether the electronic device 100 is stationary. The measurement of tilt relative to gravity is referred to as “static acceleration,” while the measurement of motion and/or vibration is referred to as “dynamic acceleration.” A gyroscope can be used in a similar fashion. In one embodiment the motion detectors are also operable to detect movement, and direction of movement, of the electronic device 100 by a user.

In one or more embodiments, the other sensors and components 124 include a gravity detector. For example, as one or more accelerometers and/or gyroscopes may be used to show vertical orientation, constant, or a measurement of tilt relative to gravity 121. Accordingly, in one or more embodiments, the one or more processors 108 can use the gravity detector to determine an orientation of the electronic device 100 in three-dimensional space 125 relative to the direction of gravity 121. If, for example, the direction of gravity 121 flows from a first portion of the display 102 to a second portion of the display 102 when the electronic device 100 is folded, the one or more processors 108 can conclude that the first portion of the display 102 is facing upward. By contrast, if the direction of gravity 121 flows from the second portion to the first, the opposite would be true, i.e., the second portion of the display 102 would be facing upward.

Other sensors and components 124 operable with the one or more processors 108 can include output components such as video outputs, audio outputs, and/or mechanical outputs. Examples of output components include audio outputs, an earpiece speaker, haptic devices, or other alarms and/or buzzers and/or a mechanical output component such as vibrating or motion-based mechanisms. Still other components will be obvious to those of ordinary skill in the art having the benefit of this disclosure.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components, and still be within the scope of the present disclosure.

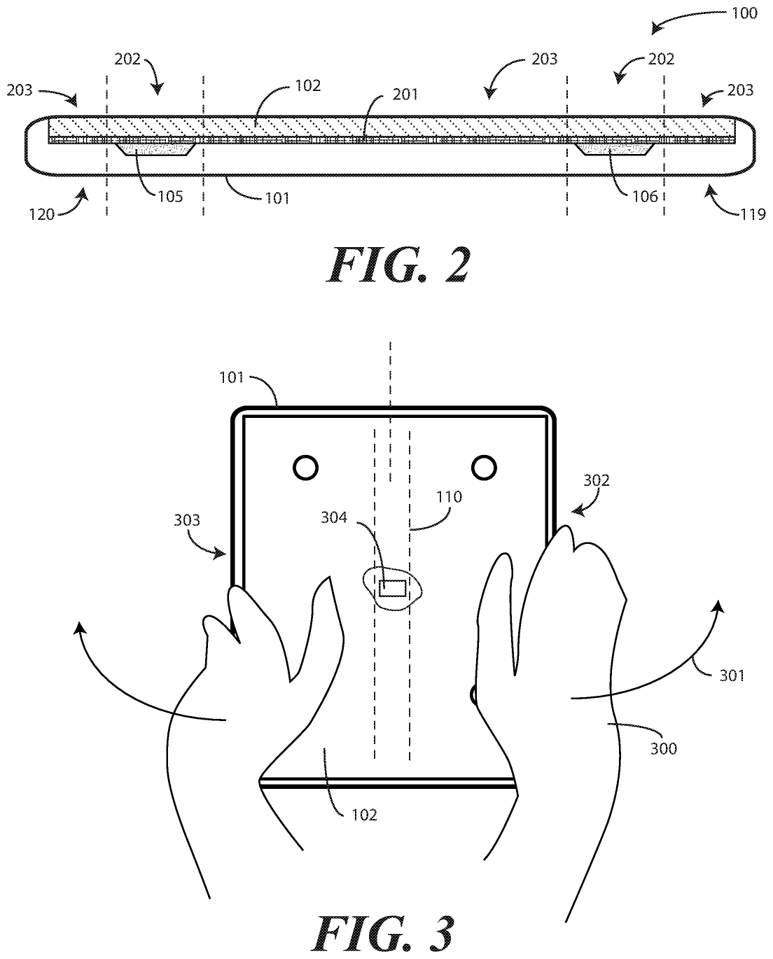

Now that the various hardware components have been described, attention will be turned to methods, systems, and use cases in accordance with one or more embodiments of the disclosure. Beginning with FIG. 2, illustrated therein is a sectional view of the electronic device 100. Shown with the electronic device 100 are the display 102 and the housing 101, each of which is flexible in this embodiment. Also shown is image capture device 105 and image capture device 106, which are positioned in the second device housing portion 120 and the first device housing portion 119, respectively.

In this illustrative embodiment, the one or more sensors 118 operable to determine the geometry of the electronic device 100 comprise a flex sensor 201. As shown in FIG. 2, the flex sensor 201 spans at least two axes (along the width of the page and into the page as viewed in FIG. 2) of the electronic device 100.

In this illustrative embodiment, each of image capture device 105 and image capture device 106 is positioned beneath the display 102. In one or more embodiments, the display 102 includes a first pixel portion 202 situated above image capture device 105 and image capture device 106 and a second pixel portion 203 situated at areas of the display 102 other than those positioned above the image capture devices 105,106.

In one embodiment, the first pixel portion 202 comprises only transparent organic light emitting diode pixels. In another embodiment, the pixels disposed in the first pixel portion 202 comprise a combination of transparent organic light emitting diode pixels and reflective organic light emitting diode pixels. Other configurations will be obvious to those of ordinary skill in the art having the benefit of this disclosure.

In one or more embodiments, the entire extent of the display 102 is available for presenting images. While some borders are shown in FIG. 2, in one or more embodiments there is no need for the device housing 101 of the electronic device 100 to include borders that picture frame the display 102. To the contrary, in one or more embodiments the display 102 can span an entire major face of the electronic device 100 so that the entirety of the major face can be used as active display area.

One way this “borderless” display is achieved is by placing the image capture devices 105,106, and optionally any other sensors beneath the first pixel portion 202 such that the image capture devices 105,106 and/or other sensors are collocated with the first pixel portion 202 or portions. This allows the image capture devices 105,106 and/or other sensors to receive signals through the transparent portions of the first pixel portion 202. Advantageously, the image capture devices 105,106 can take pictures through the first pixel portion 202, and thus need not to be adjacent, i.e., to the side of, the display 102. This allows the display 102 to extend to the border of the top of the electronic device 100 rather than requiring extra space for only the image capture devices 105,106.

In one or more embodiments, the second pixel portion 203 comprises only reflective light emitting diode pixels. Content can be presented on a first pixel portion 202 comprising only transparent organic light emitting diode pixels or sub-pixels or a combination of transparent organic light emitting diode pixels or sub-pixels and reflective organic light emitting diode pixels or sub-pixels. The content can also be presented on the second pixel portion 203 comprising only the reflective organic light emitting diode pixels or sub-pixels.

When a user desires to capture an image with either or both of image capture device 105 or image capture device 106, one or more processors (108) of the electronic device 100 cause the transparent organic light emitting diode pixels or sub-pixels to cease emitting light in one or more embodiments. This cessation of light emission prevents light emitted from the transparent organic light emitting diode pixels or sub-pixels from interfering with light incident upon the first pixel portion 202. When the transparent organic light emitting diode pixels or sub-pixels are turned OFF, they become optically transparent in one or more embodiments.

In some embodiments, the second pixel portion 203 will then remain ON when the first pixel portion 202 ceases to emit light. However, in other embodiments the second pixel portion 203 will be turned OFF as well. The requisite image capture device 105,106 can then be actuated to capture an image from the light passing through the transparent organic light emitting diode pixels or sub-pixels. Thereafter, the one or more processors (108) can resume the presentation of data along the first pixel portion 202 of the display 102. In one or more embodiments, this comprises actuating the transparent organic light emitting diode pixels or sub-pixels, thereby causing them to again begin emitting light.

Turning now to FIG. 3, a user 300 is executing a bending operation 301 upon the electronic device 100 to impart deformation at a deformation portion 110 of the electronic device 100. In this illustration, the user 300 is applying force (into the page) at the first side 302 and a second side 303 of the electronic device 100 to bend both the housing 101, which is deformable in this embodiment, and the display 102 at the deformation portion 110. Internal components disposed along flexible substrates are allowed to bend as well along the deformation portion 110. This method of deforming the housing 101 and display 102 allows the user 300 to simply and quickly bend the electronic device 100 into a desired deformed physical configuration or shape.

In other embodiments, rather than relying upon the manual application of force, the electronic device can include a mechanical actuator 304, operable with the one or more processors (108), to deform the device housing 101 and the display 102 by one or more bends. For example, a motor or other mechanical actuator can be operable with structural components to bend the electronic device 100 to predetermined angles and physical configurations in one or more embodiments. The use of a mechanical actuator 304 allows a precise bend angle or predefined deformed physical configurations to be repeatedly achieved without the user 300 having to make adjustments. However, in other embodiments the mechanical actuator 304 will be omitted to reduce component cost.

Regardless of whether the bending operation 301 is a manual one or is instead one performed by a mechanical actuator 304, it results in the device housing 101 and the display 102 being deformed by one or more bends. One result 400 of the bending operation 301 is shown in FIG. 4. In this illustrative embodiment, the electronic device 100 is deformed by a single bend 401 at the deformation portion 110. However, in other embodiments, the one or more bends can comprise a plurality of bends. Other deformed configurations will be obvious to those of ordinary skill in the art having the benefit of this disclosure.

In one embodiment, the one or more processors (108) of the electronic device 100 are operable to detect that a bending operation 301 is occurring by detecting a change in an impedance of the one or more flex sensors (201). The one or more processors (108) can detect this bending operation 301 in other ways as well. For example, the touch sensors can detect touch and pressure from the user (300). Alternatively, the proximity sensors can detect the first side 302 and the second side 303 of the electronic device 100 getting closer together. Force sensors can detect an amount of force that the user (300) is applying to the housing 101 as well. The user (300) can input information indicating that the electronic device 100 has been bent using the display 102 or other user interface. Inertial motion sensors can be used as previously described. Other techniques for detecting that the bending operation (301) has occurred will be obvious to those of ordinary skill in the art having the benefit of this disclosure.

Several advantages offered by the “bendability” of embodiments of the disclosure are illustrated in FIG. 4. For instance, in one or more embodiments the one or more processors (108) of the electronic device 100 are operable to, when the display 102 is deformed by one or more bends, present content, information, and/or user actuation targets on a first portion of the display 102 disposed to a first side 402 of the bend 401, while receiving user input in the form of touch at a second portion of the display 102 disposed to a second side 403 of the bend 401. This allows a user (300) to see content on the first portion and control the content by delivering touch input to the second portion in one or more embodiments. Additionally, where the electronic device 100 is configured in the physical configuration shown in FIG. 4, which resembles a card folded into a “tent fold,” the electronic device 100 can stand on its side or ends on a flat surface such as a table. This configuration can make the display 102 easier for the user (300) to view since they do not have to hold the electronic device 100 in their hands.

In one or more embodiments, the one or more processors (108) are operable to detect the number of folds in the electronic device 100 resulting from the bending operation 301. In one embodiment, after determining the number of folds, the one or more processors (108) can partition the display 102 of the electronic device 100 as another function of the one or more folds. Since there is a single bend 401 here, in this embodiment the display 102 has been partitioned into a first portion and a second portion, with each portion being disposed on opposite sides of the “tent.”

In one or more embodiments, the bending operation 301 can continue from the physical configuration of FIG. 4 until the electronic device 100 is fully folded at the deformation portion 110 as shown in FIG. 5. Embodiments of the disclosure contemplate that a user (300) may hold the electronic device 100 in one hand when in this deformed physical configuration. For example, the user may use the electronic device 100 as a smartphone in the folded configuration of FIG. 5, while using the electronic device 100 as a tablet computer in the unfolded configuration of FIG. 1 or FIG. 3.

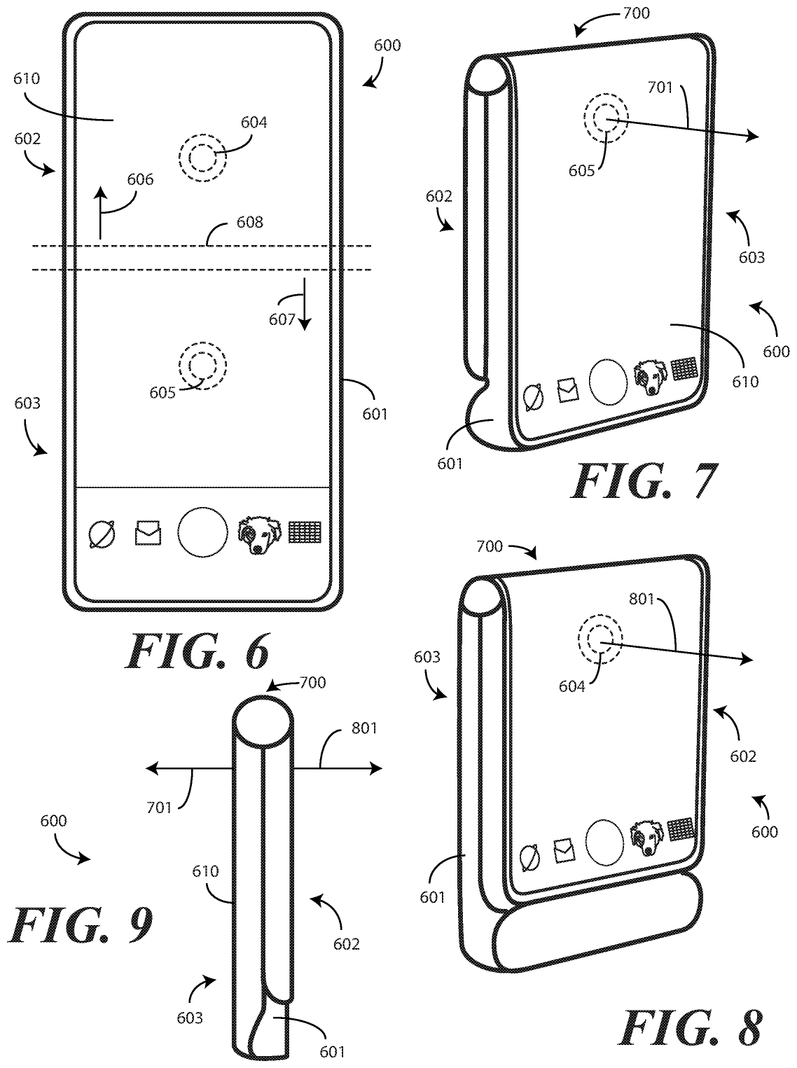

Turning now to FIGS. 6-9, illustrated therein is another explanatory electronic device 600 configured in accordance with one or more embodiments of the disclosure. While the physical configuration of the electronic device 600 of FIGS. 6-9 differs somewhat from the electronic device (100) of FIGS. 1-5, in one or more embodiments the schematic diagram associated with the electronic device 600 includes some or all of the same components described above with reference to the block schematic diagram (107) of FIG. 1. Accordingly, in one or more embodiments the electronic device 600 includes one or more processors (108), one or more sensors (118) operable to determine a geometry of the electronic device 600, and optionally an image capture analysis/synthesis manager (122).

As with the electronic device (100) of FIGS. 1-5, the electronic device 600 of FIGS. 6-9 is a deformable electronic device, having both a device housing 601 and a display 610 that can be deformed by one or more bends, deformations, or folds. The electronic device 600 of FIGS. 6-9 is shown in an undeformed configuration in FIG. 6, and in a fully deformed configuration in FIGS. 7-9. More specifically, the geometry of the electronic device 600 defines a plane in FIG. 6, while a first device housing portion 602 is abutting a second device housing portion 603 in FIGS. 7-9.

As before, the electronic device 600 includes at least one imager. In the illustrative embodiment of FIGS. 6-9, the electronic device 600 includes at least one imager 604 disposed to a first side 606 of a deformable portion 608 of the electronic device 600, and at least one other imager 605 disposed to a second side 607 of the deformable portion 608 of the electronic device 600. In this illustrative embodiment, both the at least one imager 604 and the at least one other imager 605 are situated beneath the display 610 of the electronic device 600.

As shown in FIGS. 7-9, in one or more embodiments the geometry of the electronic device 600 defines a bend 700 with at least one imager 604 situated on the first device housing portion 602 and positioned on a first side of the bend 700 and the at least one other imager 605 situated on the second device housing portion 603 positioned to a second side of the bend 700. This results in a field of view 801 of the at least one imager 604 oriented in a direction that is substantially opposite (exactly opposite in this example) from another field of view 701 of the at least one other imager 605.

In one or more embodiments, each of the field of view 801 of the at least one imager 604 and the other field of view 701 of the at least one other imager 605 is a 180-degree field of view. This allows the at least one imager 604 and the at least one other imager 605 to capture 360-degree panoramic images when the electronic device 600 is deformed such that the first device housing portion 602 carrying the at least one imager 604 abuts the second device housing portion 603 carrying the at least one other imager 605 with the field of view 801 and the other field of view 701 oriented in substantially opposite directions. In other embodiments, one or both of the field of view 801 and the other field of view 701 can be less than 180-degrees. In some embodiments, the field of view 801 and the other field of view 701 can be adjusted by moving lenses situated between the sensors of the at least one imager 604 and the at least one other imager 605 and the display 610.

The electronic device 600 includes one or more sensors (118) operable to detect a geometry of the electronic device 600. Additionally, the electronic device 600 includes one or more processors (108) operable to combine at least one image captured by the at least one imager 604 and at least one other image captured by the at least one other imager 605. For example, since the field of view 801 of the at least one imager 604 is oriented substantially in the opposite direction from the field of view 701 of the at least one other imager 605, in one or more embodiments the one or more processors (108) can process the at least one image captured by the at least one imager 604 and the at least one other image captured by the at least one other imager 605 as a function of this deformed geometry by synthesizing the at least one image and the at least one other image into a panoramic image. Where the field of view 801 of the at least one imager 604 and the other field of view 701 of the at least one other imager 605 are sufficiently wide, this allows the composite image to provide a 360-degree view around the electronic device 600 without any dongle or attachment being required.

The electronic device 600 of FIGS. 6-9 thus provides a dual image-capture device, with at least one imager 604 and at least one other imager 605 situated beneath a display 610. In one or more embodiments, the device housing 601 is bendable such that the display 610 bends in an outward facing configuration, with the display 610 visible even when the device housing 601 is fully bend such that the first device housing portion 602 and the second device housing portion 603 abut. Working in tandem with the image capture analysis/synthesis manager 122, the one or more processors (108) define a higher-level logical image capture system. To wit, in one or more embodiments the one or more processors (108) have the ability to stitch, merge, synthesize, concatenate, and superimpose at least one image captured by the at least one imager 604 and at least one other image captured by the at least one other imager 605.

In one or more embodiments, this processing of the at least one image and the at least one other image occurs as a function of the geometry of the electronic device 600. For example, note that the at least one imager 604 and the at least one other imager 605 are symmetrically situated relative to the deformation portion 608. Where the at least one imager 604 and the at least one other imager 605 are so situated, the fully folded configuration of FIGS. 7-9 causes the central axes of the field of view 801 and the other field of view 701 to be collinear. Said differently, this allows the field of view 801 and the other field of view 701 to situate on the opposite sides of the electronic device 600 centered along the same central axis.

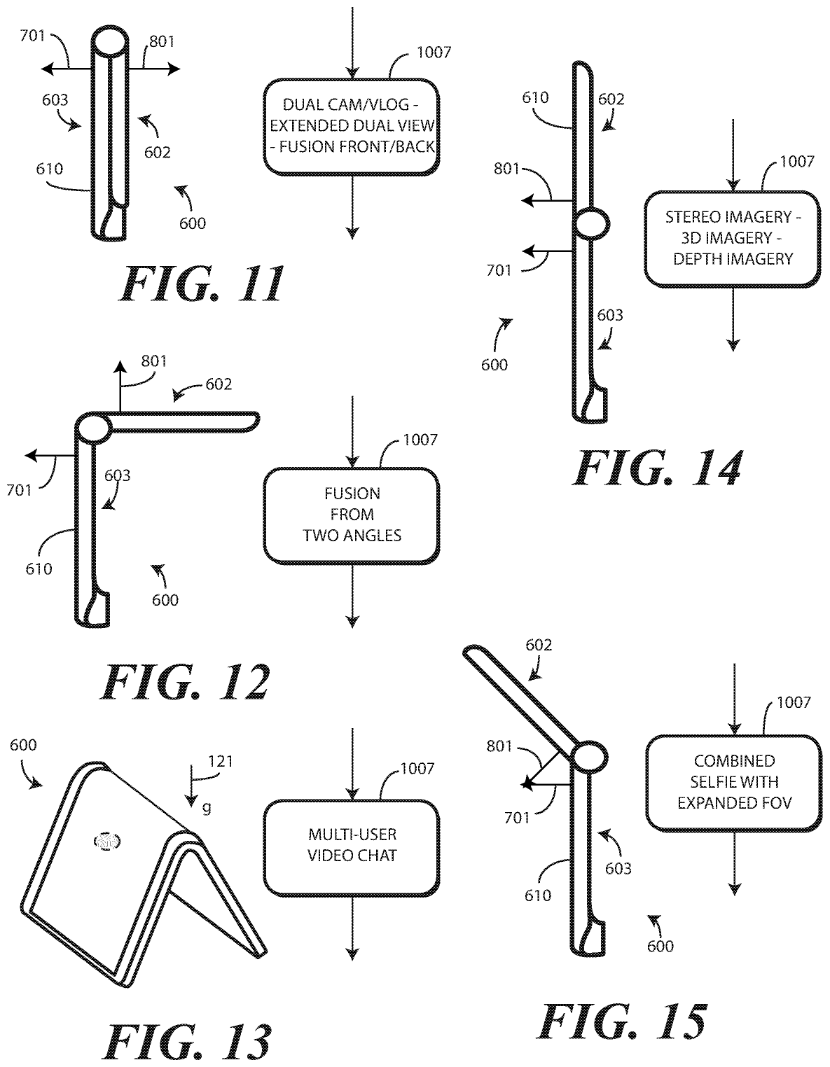

In one or more embodiments, the one or more sensors (118) detect a geometry of the electronic device 600. In one or more embodiments, the one or more sensors (118) detecting the geometry of the electronic device 600 make this geometry known to the one or more processors (108) and the image capture analysis/synthesis manager (122). In one or more embodiments, the one or more processors (108) process the at least one image and the at least one other image as a function of the geometry of the electronic device 600, as will be described in more detail below with reference to FIGS. 11-22.

Turning now to FIG. 10, illustrated therein is one explanatory method 1000 for using the electronic device (600) of FIGS. 6-9, the electronic device (100) of FIGS. 1-5, or other electronic devices configured in accordance with one or more embodiments of the disclosure. The method 1000 advantageously solves several problems associated with prior art devices. First, it eliminates the need for any external accessory to be attached to an electronic device when capturing panoramic images. Second, the method 1000 allows an electronic device to dynamically switch from its image capture devices from being used as standard imagers to being used as panoramic imagers or other types of imagers. Next, the method 1000 provides new and unique features that allow users engaged in videoconferencing or creating new content to further extend their creativity. Other benefits and advantages offered by the method 1000 will be obvious to those of ordinary skill in the art having the benefit of this disclosure.

Beginning at step 1001, an image capture application operable with at least two image capture devices is actuated. At step 1002, one or more sensors of the electronic device determine a geometry of the electronic device.

Decision 1003 determines whether user input is received defining an operating mode for the at least one imager and at least one other imager of the electronic device. For example, a user may configure the at least one imager and at least one other imager to capture a “selfie” by delivering user input to a user interface of the electronic device. Alternatively, the user may desire to create an image by superposition, as will be described below with reference to FIG. 19, and may provide user input to the user interface to cause this configuration to occur. Where such user input is received, the method 1000 moves to step 1005 where the operational mode is defined by the user input.

Where user input specifically defining an operating mode is not received, the method 1000 moves to step 1004 where the operating mode of the one or more processors, the at least one imager, and the at least one other imager is determined by the geometry of the electronic device. Some examples of how this can occur are described below with reference to FIGS. 11-15.

In one or more embodiments where the angle of the bend in a deformation is around 135 degrees, with the display positioned along the concave side of the electronic device, step 1004 results in the at least one and the at least one other imager being configured in a portrait mode with the field of view of the at least one imager and the other field of view of the at least one other imager partially overlapping. This allows the one or more processors to synthesize at least one image captured by the at least one imager and at least one other image captured by the at least one other imager to create combined portraits or selfies having an increased field of view beyond what either the at least one imager or at least one other imager could capture on their own.

In one or more embodiments, when the first device housing portion and second device housing portion of the electronic device substantially define a plane, step 1004 can result in one of a variety of modes. Illustrating by example, in one embodiment step 1004 causes the at least one imager and the at least one imager to capture stereo images. In another embodiment, step 1004 causes the at least one imager and the at least one other imager to capture three-dimensional images. In yet another embodiment, step 1004 causes the at least one imager and the at least one other imager to capture depth scans of objects. In one or more embodiments, a user can make a selection from these three options by delivering user input to a user interface of the electronic device.

In one or more embodiments, when the angle of the bend of the deformation portion is around 225 degrees, with the display positioned along the convex side of the electronic device, step 1004 results in the at least one and the at least one other imager being configured in a wide angle or landscape mode. In one or more embodiments, this again results in the field of view of the at least one imager and the other field of view of the at least one other imager partially overlapping. This allows the one or more processors to synthesize at least one image captured by the at least one imager and at least one other image captured by the at least one other imager to create combined wide-angled landscape shots having an increased field of view beyond what either the at least one imager or at least one other imager could capture on their own.

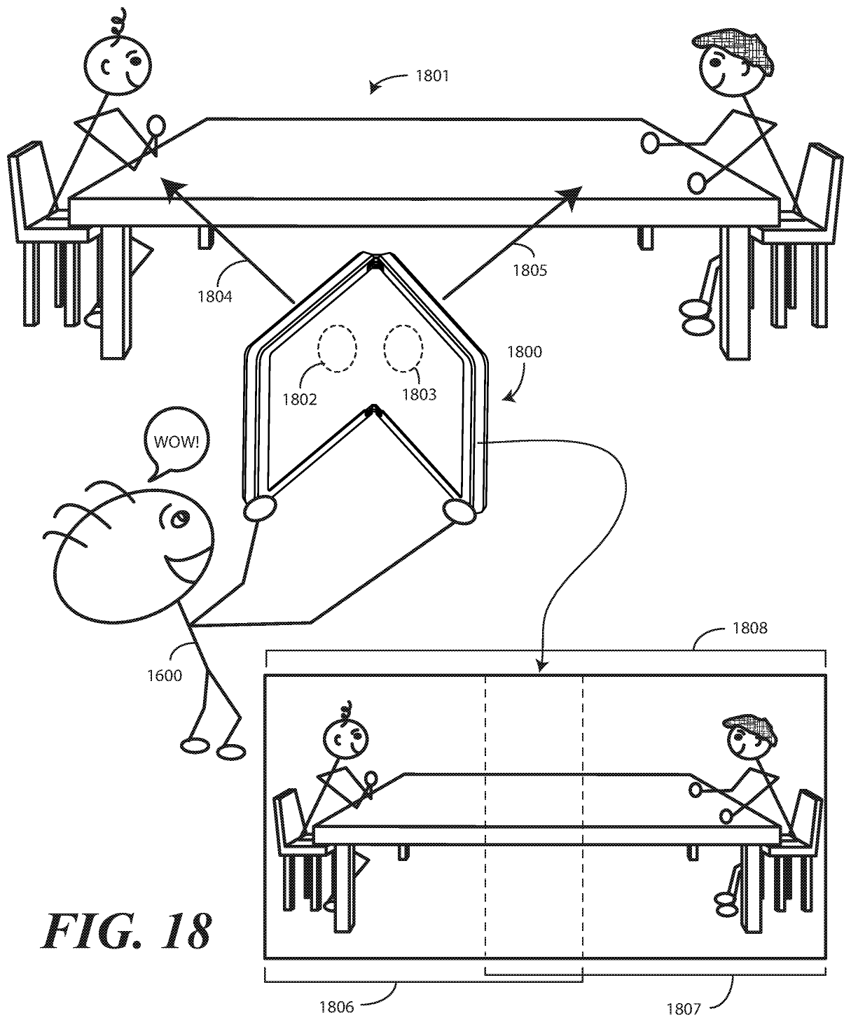

In one or more embodiments, when the angle of the bend of the deformation portion is around 270 degrees, with the display positioned along the convex side of the electronic device, step 1004 results in a “fusion” mode. As used herein, “fusion” modes result in the one or more processors of the electronic device performing a combinatory operation with at least one image captured by the at least one imager and at least one other image captured by the at least one other imager. These combinatory functions can include superposition, concatenation, partial superposition, and other combinatory features. Examples of this will be described below with reference to FIGS. 18-19.

In one or more embodiments, when the angle of the bend of the deformation portion is around 315 degrees, with the display positioned along the convex side of the electronic device, step 1004 results in the at least one imager and the at least one imager being placed into one of two operating modes. If a person is holding the electronic device, step 1004 results in the electronic device being placed in a portrait mode in one or more embodiments. An example of this will be described below with reference to FIG. 19. If the electronic device is positioned on a flat surface, such that the deformation portion is oriented upward, step 1004 can cause the at least one imager and the at least one other imager to enter a multi-user video chat mode in one or more embodiments. One example of this will be described below with reference to FIG. 20.

In one or more embodiments, when the electronic device is deformed such that the first device housing portion situated to one side of the deformation portion and second device housing portion situated to a second side of the deformation portion abut, as illustrated in FIGS. 7-9 above, step 1004 can result in a multitude of modes of operation. In one embodiment, a fusion mode occurs where the at least one imager captures an image of the user, while the at least one other imager captures an image depicting what the user is seeing. Thus, in this mode the combined image would depict both what the user sees and the user's face.

In another embodiment, where the at least one imager captures a picture of a person and the at least one other imager captures a picture of another person, the fusion operation presents both users in the image. In still another embodiment, step 1004 results in a panoramic or semi-panoramic mode of operation in which images captured by each of the at least one imager and the at least one other imager can be synthesized into semi-panoramic or panoramic images. In yet another embodiment, step 1004 results in the at least one imager and the at least one other imager being placed in a dual-imager video logging mode of operation. In still another embodiment, step 1004 results in the at least one imager and the at least one other imager being placed in a creative movie making mode of operation.

At step 1006, the at least one imager and the at least one other imager capture at least one image and at least one other image, respectively. At step 1007, one or more processors of the electronic device process the at least one image and the at least one other image. Where the method 1000 proceeded through step 1005, the processing occurring at step 1007 occurs as a function of the user input received at the user interface. Where the method 1000 proceeded through step 1004, the processing occurring at step 1007 occurs as a function of the geometry of the electronic device. Once the processing is complete, the output—which is a composite image or video in one or more embodiments—is rendered at step 1008.

The processing occurring at step 1007 can optionally occur as a function of a device orientation listener 1009 as well in one or more embodiments. The device orientation listener 1009 is a logic algorithm that receives input from the one or more sensors and other components of the electronic device that help to determine an operating mode automatically without the need for user input. Illustrating by example, in one or more embodiments the device orientation listener 1009 can check the inertial motion units (where included) of the electronic device to determine whether the at least one imager and the at least one other imager are facing down upon the user to capture the most flattering selfie. Where they are not, the one or more processors of the electronic device may prompt the user to reorient the electronic device to improve the selfie image quality. The device orientation listener 1009 may also check to see if one of the at least one imager or at least one other imager is inadvertently covered by a user's hand. Where it is, the one or more processors of the electronic device may prompt the user to move their hand, and so forth. Other examples of sensor information that can be processed through the device orientation listener 1009 will be obvious to those of ordinary skill in the art having the benefit of this disclosure.

Turning now to FIGS. 11-15, illustrated therein are some of the different operating modes described above. It should be noted that while particular examples of operating modes corresponding to particular geometries of the electronic device are illustrated in FIGS. 11-15, those of ordinary skill having the benefit of this disclosure will understand that in many embodiments, the operating modes yielding composite images, e.g., expanded filed of view images, semi-panoramic images, or panoramic images created by concatenation, superposition, or other techniques, will be applicable to other geometries than those shown in a particular example. For instance, while FIG. 13 describes a multi-user video chat operating mode when the electronic device is in a tent position, the geometry of FIG. 13 could also be used to create fusion images in accordance with the example described with reference to FIG. 12, and so forth.

Beginning with FIG. 11, in this example the electronic device 600 is deformed such that the first device housing portion 602 is abuts the second device housing portion 603 with the display 610 positioned to the exterior of the deformation. This is referred to as a “360-degree” bend. As described above with reference to FIGS. 7-9, this results in a field of view 801 of at least one imager (604) being oriented in a direction substantially opposite another field of view 701 of the at least one other imager (605).

In one or more embodiments, the processing occurring at step 1007 of the method (1000) of FIG. 10 comprises synthesizing at least one image captured by the at least one imager (604) and at least one other image captured by the at least one other imager (605) into a panoramic image in one or more embodiments. In one or more other embodiments, the processing occurring at step 1007 of the method (1000) of FIG. 10 comprises superimposing at least a portion of at least one image captured by the at least one imager (604) and at least a portion of at least one other image captured by the at least one other imager (605).

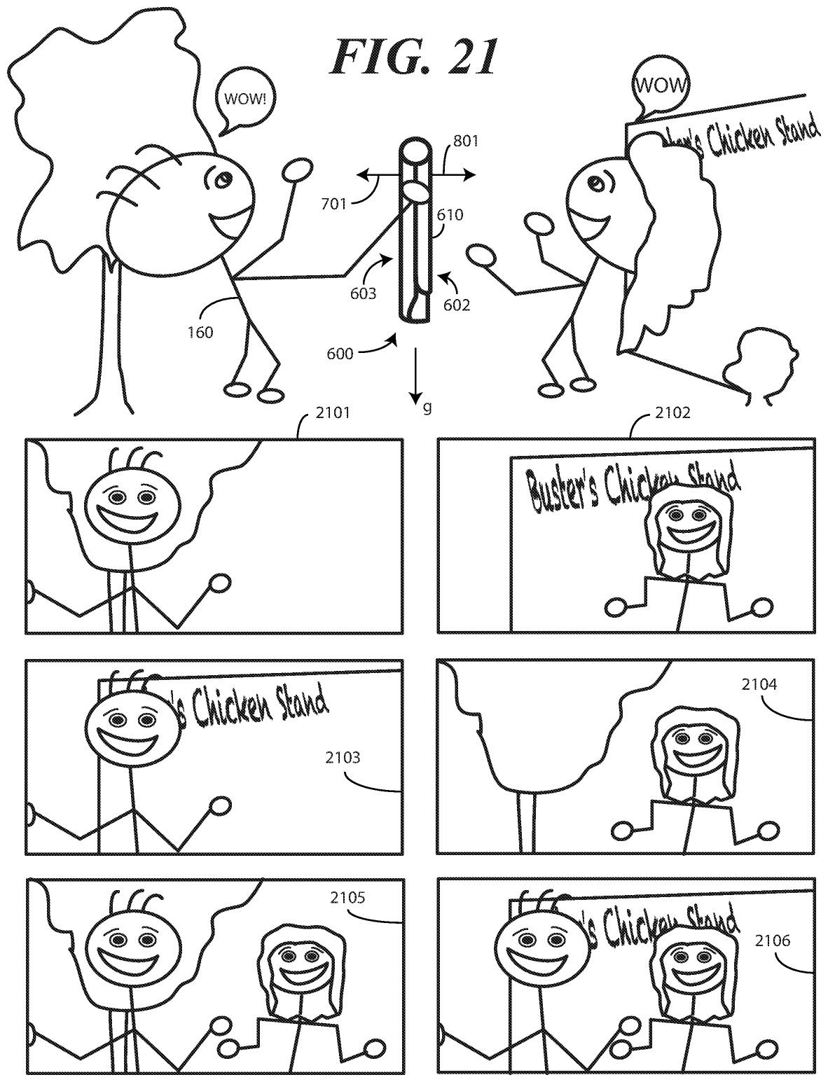

In one or more embodiments, the processing occurring at step 1007 of the method (1000) of FIG. 10 comprises synthesizing at least one image captured by the at least one imager (604) and at least one other image captured by the at least one other imager (605) into a dual imager video logging composite image. In still other embodiments, the processing occurring at step 1007 of the method (1000) of FIG. 10 comprises performing a fusion operation on at least one image captured by the at least one imager (604) and at least one other image captured by the at least one other imager (605), examples of which will be described below with reference to FIG. 21.

In another embodiment, the processing occurring at step 1007 of the method (1000) of FIG. 10 comprises performing a concatenation operation on at least one image captured by the at least one imager (604) and at least one other image captured by the at least one other imager (605) showing both a user and what the user sees. In still another embodiment, the processing occurring at step 1007 of the method (1000) of FIG. 10 comprises performing a combinatory operation on at least one image captured by the at least one imager (604) and at least one other image captured by the at least one other imager (605) to create semi-panoramic or panoramic images. In still another embodiment, the processing occurring at step 1007 of the method (1000) of FIG. 10 comprises performing a fusion operation on at least one image captured by the at least one imager (604) and at least one other image captured by the at least one other imager (605) placing the electronic device into a creative movie making mode of operation. These examples of the processing that can occur at step 1007 when the electronic device 600 is in the 360-degree fold are illustrative only, as others will be obvious to those of ordinary skill in the art having the benefit of this disclosure. In one or more embodiments, the composite image resulting from step 1007 when the electronic device 600 is in the geometry shown in FIG. 11 comprises at least a semi-panoramic concatenation of the at least one image and the at least one other image.

Turning now to FIG. 12, illustrated therein is the electronic device 600 oriented in a “315-degree” fold where a first device housing portion 602 is substantially orthogonal with the second device housing portion 603. This results in the first device housing portion 602 being oriented substantially orthogonally with the second device housing portion 603. The display 610 is positioned on the convex side of the electronic device 600, which results in a field of view 801 of at least one imager (604) being oriented substantially orthogonally with another field of view 701 of at least one other imager (605).

In one or more embodiments, the processing occurring at step 1007 of the method (1000) of FIG. 10 comprises superimposing at least a portion of at least one image captured by the at least one imager (604) upon at least a portion of at least one other image captured by the at least one other imager (605). In one or more embodiments, the processing occurring at step 1007 of the method (1000) of FIG. 10 comprises superimposing an entirety of at least one image captured by the at least one imager (604) upon an entirety of at least one other image captured by the at least one other imager (605).

The orientation of the electronic device 600 shown in FIG. 12 is that which might occur if a person were holding the electronic device 600 in their hand. By contrast, turning now to FIG. 13, in this embodiment the electronic device 600 has been transitioned to the tent position described above with reference to FIG. 4. In one or more embodiments, one or more sensors of the electronic device 600 can determine that the deformation portion 608 defines an apex of the electronic device 600 relative to the direction of gravity 121. In one or more embodiments, when this occurs the processing occurring at step 1007 of the method (1000) of FIG. 10 comprises performing using at least one image captured by the at least one imager (604) and at least one other image captured by the at least one other imager (605) in a video conferencing mode. One example of this is shown below with reference to FIG. 20.

Turning now to FIG. 14, illustrated therein is the electronic device 600 with the first device housing portion 602 and the second device housing portion 603 positioned at a “180-degree” bend. In this geometry the first device housing portion 602 and the second device housing portion 603 define a plane. This results in a field of view 801 of at least one imager (604) being oriented substantially parallel with another field of view 701 of at least one other imager (605).

In one or more embodiments, the processing occurring at step 1007 of the method (1000) of FIG. 10 can take one of multiple forms when the electronic device 600 is in this geometry. Illustrating by example, in one or more embodiments the processing occurring at step 1007 of the method (1000) of FIG. 10 comprises synthesizing at least one image captured by the at least one imager (604) and at least one other image captured by the at least one other imager (605) to create a three-dimensional image. In another embodiment, the processing occurring at step 1007 of the method (1000) of FIG. 10 comprises synthesizing at least one image captured by the at least one imager (604) and at least one other image captured by the at least one other imager (605) to create a depth map. In still another embodiment, the processing occurring at step 1007 of the method (1000) of FIG. 10 comprises synthesizing at least one image captured by the at least one imager (604) and at least one other image captured by the at least one other imager (605) to create a stereo image.

Turning now to FIG. 15, illustrated therein is the electronic device 600 oriented in a concave bend where a first device housing portion 602 and the second device housing portion 603 define a non-orthogonal angle. The display 610 is positioned on the concave side of the electronic device 600, which results in a field of view 801 of at least one imager (604) and another field of view 701 of at least one other imager (605) extending distally from the non-orthogonal angle defined by the first device housing portion 602 and the second device housing portion 603.

In one or more embodiments, the processing occurring at step 1007 of the method (1000) of FIG. 10 comprises superimposing at least a portion of at least one image captured by the at least one imager (604) upon at least a portion of at least one other image captured by the at least one other imager (605). The geometry of FIG. 15 can be used, for example, to capture a “super selfie” with the at least one image captured by the at least one imager (604) and the at least one other image captured by the at least one other imager (605) partially overlapping such that the composite image resulting from the superposition is defined by a wider field of view than that of either the at least one imager (604) or the at least one other imager (605).

In one or more embodiments, the amount that the at least one image and the at least one other image are superimposed is a function of the angle of the bend. For example, the angle between the first device housing portion 602 and the second device housing portion 603 in FIG. 15 is about 150 degrees. Accordingly, the portion of the at least one image that is superimposed upon the portion of the at least one other image can be a function of this angle. In one or more embodiments, rather than superimposing portions, non-overlapping portions of the at least one image or the at least one other image can be appended to overlapping portions of the other of the at least one image or the at least one other image as well.

Examples of these processing mechanisms are depicted in FIGS. 16-21. Beginning with FIG. 16, a user 1600 is shown holding an electronic device 600 with that electronic device 600 being positioned in the geometry of FIG. 15. Specifically, the electronic device 600 oriented in a concave bend where a first device housing portion 602 and the second device housing portion 603 define a non-orthogonal angle. The display 610 is positioned on the concave side of the electronic device 600, which results in a field of view 801 of at least one imager (604) and another field of view 701 of at least one other imager (605) extending distally from the non-orthogonal angle defined by the first device housing portion 602 and the second device housing portion 603.

In one or more embodiments, one or more sensors (118) of the electronic device 600 detect the bending operation that the user 1600 used to deform the electronic device 600 with the bend resulting in the at least one imager (604) being situated to one side of the bend and the at least one other imager (605) being situated to another side of the bend. The at least one imager (604) then captures at least one image 1601, while the at least one other imager (605) captures at least one other image 1602.

In one or more embodiments, the one or more processors (108) of the electronic device then synthesize the at least one image 1601 and the at least one other image 1602 as a function of the angle of the bend to create a composite image 1603. As shown in FIG. 16, the field of view of the composite image 1603 is greater than the field of view of either the at least one image 1601 or the at least one other image 1602 due to the partial overlap of the field of view 801 of the at least one imager (604) and the other field of view 701 of the at least one other imager (605). This overlap is defined by the angle of the bend. Accordingly, less bend means less overlap, while more bend means more overlap.

As shown, this allows the user 1600 to take a “super selfie” with the at least one image 1601 and the at least one other image 1602 either partially overlapping or concatenated together to create an extended image having a wider field of view. In one or more embodiments, the one or more processors (108) of the electronic device superimpose at least a portion of at least one image 1601 captured by the at least one imager (604) upon at least a portion of at least one other image 1602 captured by the at least one other imager (605) to create the composite image 1603.

By contrast, turning now to FIG. 17, here the user 1600 is shown holding the electronic device 600 with the first device housing portion 602 and the second device housing portion 603 bent to a wider angle. Specifically, the electronic device 600 oriented in a convex bend where a first device housing portion 602 and the second device housing portion 603 define a non-orthogonal angle. The display 610 is positioned on the convex side of the electronic device 600, which results in a field of view 801 of at least one imager (604) and another field of view 701 of at least one other imager (605) extending distally from the convex side of the non-orthogonal angle defined by the first device housing portion 602 and the second device housing portion 603.

In one or more embodiments, one or more sensors (118) of the electronic device 600 detect the bending operation that the user 1600 used to deform the electronic device 600 with the bend resulting in the at least one imager (604) being situated to one side of the bend and the at least one other imager (605) being situated to another side of the bend. The at least one imager (604) then captures at least one image 1701, while the at least one other imager (605) captures at least one other image 1702.

In one or more embodiments, the one or more processors (108) of the electronic device then synthesize the at least one image 1701 and the at least one other image 1702 as a function of the angle of the bend to create a composite image 1703. As shown in FIG. 17, the field of view of the composite image 1703 is greater than that of the composite image (1603) of FIG. 16 due to the fact that the angle oriented toward the user 1600 is convex rather than concave. Moreover, the field of view of the composite image 1703 is greater than the field of view of either the at least one image 1601 or the at least one other image 1602 due to the reduced partial overlap of the field of view 801 of the at least one imager (604) and the other field of view 701 of the at least one other imager (605). This overlap is again defined by the angle of the bend.

As shown, this allows the user 1600 to take a “mega selfie” with the at least one image 1701 and the at least one other image 1702 either partially overlapping or concatenated together to create an extended image having a wider field of view. This allows the composite image 1703 to show not only the user 1600, but the ever so tall tree situated behind the user 1600. In one or more embodiments, the one or more processors (108) of the electronic device superimpose at least a portion of at least one image 1601 captured by the at least one imager (604) upon at least a portion of at least one other image 1602 captured by the at least one other imager (605) to create the composite image 1603. In one or more embodiments, rather than superimposing portions, non-overlapping portions of the at least one image 1701 or the at least one other image 1702 can be appended to overlapping portions of the other of the at least one image 1701 or the at least one other image 1702 as well.

Turning now to FIG. 18, a similar effect of expanding the overall field of view by deforming the electronic device 600 can be seen. In FIG. 18, a user 1600 using an electronic device 1800 configured in accordance with embodiments of the disclosure wishes to capture a picture of a scene 1801 of two friends sitting at a long boardroom table. This electronic device 1800 includes a hinge situated between a first device housing and a second device housing, with the first device housing being pivotable about the hinge relative to the second device housing. The electronic device 1800 includes at least one imager 1802 carried by the first device housing and at least one other imager 1803 carried by the second device housing.

A display faces the user, and the at least one imager 1802 and the at least one other imager 1803 are positioned on major faces of the first device housing and second device housing, respectively, opposite the major faces supporting the display (the side of the electronic device 1800 facing the boardroom table and away from the user 1600). Where included, this second display can be either a flexible display spanning the hinge (similar to the display (610) of FIGS. 6-9), or alternatively could be two displays, with a first display supported by the first device housing and a second display supported by the second device housing, with the at least one imager 1802 being positioned either beneath the first display or next to the first display, and with the at least one other imager 1803 being positioned either beneath the second display or next to the second display. Alternatively, one outwardly facing display could be positioned on either the first device housing or the second device housing, with the corresponding imager positioned either beneath that display or next to that display, and with the other imager simply supported by a surface of the other device housing. Other configurations for the electronic device 1800 will be obvious to those of ordinary skill in the art having the benefit of this disclosure.

In FIG. 18, given the distance between the user 1600 and the scene 1801, the friends are outside of the field of view of a single imager, be it the at least one imager 1802 or the at least one other imager 1803. However, since the electronic device 1800 is configured in accordance with one or more embodiments of the disclosure, the user 1600 can quickly, intuitively, and easily still capture the shot of the scene 1801.

To do this, the user 1600 simply performs a bending operation bending the first device housing about the hinge relative to the second device housing such that the field of view 1804 of the at least one imager 1802 diverges from the other field of view 1805 of the at least one other imager 1803. Since each field of view 1804,1805 has an angle of between 135 degrees and 180 degrees in this example, the bend shown in FIG. 18 allows these fields of view 1804,1805 to diverge while still at least partially overlapping.

In one or more embodiments, one or more sensors of the electronic device 1800 detect the bending operation and alter the operating modes of the at least one imager 1802 and the at least one other imager 1803. To wit, when the at least one imager 1802 and the at least one other imager 1803 capture at least one image 1806 and at least one other image 1807, respectively, one or more processors operating in the electronic device 1800 can parse the at least one image and the at least one other image for overlapping content to determine how much of the field of view 1804 of the at least one imager 1802 and the field of view 1805 of the at least one other imager 1803 overlap.

From the knowledge of this overlap, in one or more embodiments the one or more processors of the electronic device 1800 then synthesize the at least one image 1806 and the at least one other image 1807 as a function of the overlap of the field of view 1804 and other field of view 1805 to create a composite image 1808. As shown in FIG. 18, the fact that the entire scene 1801 appears in the composite image 1808 confirms that the field of view of the composite image 1808 is greater than the field of view of either the at least one image 1806 or the at least one other image 1807.

As shown, this allows the user 1600 to take a semi-panoramic image. The one or more processors of the electronic device 1800 create this semi-panoramic image by either partially overlapping the at least one image 1806 and the at least one other image 1807 or concatenating the same together to expand the combined fields of view of the imagers into a semi-panoramic field of view. In one or more embodiments, the one or more processors of the electronic device 1800 superimpose at least a portion of at least one image 1806 captured by the at least one imager 1802 upon at least a portion of at least one other image 1807 captured by the at least one other imager 1803 to create the composite image 1808.

Turning now to FIG. 19, illustrated therein is an example of the one or more processors (108) of the electronic device 600 performing a fusion operation. Here the user 1600 is shown holding the electronic device 600 with the first device housing portion 602 and the second device housing portion 603 bent to a substantially orthogonal angle. Specifically, the electronic device 600 oriented in a convex bend where a first device housing portion 602 and the second device housing portion 603 define an orthogonal angle. The display 610 is positioned on the convex side of the electronic device 600, which results in a field of view 801 of at least one imager (604) being oriented substantially orthogonally with another field of view 701 of at least one other imager (605).

In one or more embodiments, one or more sensors (118) of the electronic device 600 detect the bending operation that the user 1600 used to deform the electronic device 600 with the bend resulting in the at least one imager (604) being situated to one side of the bend and the at least one other imager (605) being situated to another side of the bend. In one or more embodiments, the one or more processors (108) then change the operating mode of the at least one imager (604) and the at least one other imager (605) as a function of this new geometry.

In FIG. 19, the at least one imager (604) then captures at least one image, while the at least one other imager (605) captures at least one other image. Since the electronic device 1800 is bent with the first device housing portion 602 and the second device housing portion 603 defining a substantially orthogonal angle, this results in the at least one image depicting stars above the head of the user 1600, while the at least one other image depicts the user 1600.

In one or more embodiments, the one or more processors (108) of the electronic device then synthesize the at least one image and the at least one other image as a function of the geometry of the electronic device 600. Here, the synthesis comprises a fusion operation combining portions of the at least one image and the at least one other image. As shown, the composite image 1901 extracts portions of the at least one image, here the depiction of the user, and fuses them together with portions extracted from the at least one other image, here the sky and stars. Thus, after the fusion operation, the composite image 1901 depicts the user floating in the sky among the starts. Ordinarily, such optical illusions would require expensive computer equipment, hours of editing, and advanced knowledge of photograph editing software. By contrast, in FIG. 19 all the user 1600 needs to do is bend the electronic device 600 to an orthogonal angle with the at least one imager (604) and the at least one other imager (605) oriented outwardly from the convex side of the electronic device 600, and the one or more processors (108) automatically do the rest by performing the fusion operation automatically. Advantageously, embodiments of the disclosure allow content creators, such as the user 1600, to quickly and easily show off their creativity by utilizing cool new features such as those provided by embodiments of the disclosure and those described here with reference to FIG. 19.

Turning now to FIG. 20, illustrated therein is another operating mode of the electronic device 600, namely, a videoconferencing mode of operation. As shown, the electronic device 600 has been bent into a tent position, with the first device housing portion 602 and the second device housing portion 603 having their ends placed upon a table with the apex of the tent facing upward. In one or more embodiments, one or more sensors (118) of the electronic device 600 detect not only this geometry, but the direction of gravity 121 running downward from the apex of the tent fold of the electronic device 600 and between the ends of the first device housing portion 602 and the second device housing portion 603. Accordingly, the one or more processors (108) of the electronic device 600 use this information to alter the mode of operation of the at least one imager (604) and the at least one other imager (605).

In one or more embodiments, since the at least one imager (604) is disposed to a first side of the bend and the at least one other imager (605) is disposed to a second side of the bend while the electronic device 600 is in this tent position, the one or more processors (108) transition the at least one imager (604) and the at least one other imager (605) into a video conferencing mode of operation in which the at least one imager (604) captures video of a first person within a field of view 701 of the at least one imager (604) and video of a second person within another field of view 801 of the at least one other imager (605). This videoconferencing video of each person can then be transmitted across a network for incorporation into a video conference.

Turning now to FIG. 21, illustrated therein is are additional examples of a fusion operation that can occur using an electronic device 600 configured in accordance with one or more embodiments of the disclosure. As shown, the user 1600 has deformed the electronic device 600 into a 360-degree bend such that the first device housing portion 602 is abuts the second device housing portion 603 with the display 610 positioned to the exterior of the deformation. This results in a field of view 801 of at least one imager (604) being oriented in a direction substantially opposite another field of view 701 of the at least one other imager (605).

In this example, the field of view 701 of the at least one other imager (605) captures images of the user 1600, while the other field of view 801 of the at least one imager (604) captures images of his girlfriend. The user 1600 is standing in front of a tree, while his girlfriend is standing in front of Buster's Chicken Stand, a very popular local eatery. One or more sensors (118) of the electronic device 600 detect not only the geometry of the electronic device in this example, but also the content of the at least one image 2101 captured by the at least one imager (604) and the at least one other image 2102 captured by the at least one other imager (605) to perform fusion operations on the same. The fusion operations can take various forms.

As shown in FIG. 21, the at least one image 2101 shows the user 1600 and the tree. Similarly, the at least one other image 2102 shows the girlfriend and Buster's Chicken Stand. In one or more embodiments, the one or more processors (108) of the electronic device 600 transform and project one or both of the at least one image 2101 and the at least one other image 2102, select portions of the at least one image 2101 and the at least one other image 2102, and deduplicate redundant and/or overlapping portions of the at least one image 2101 and the at least one other image 2102 to create the fusion view depicted in the resulting composite image.

In one or more embodiments, the fusion view of the composite image includes background elements from one image and foreground elements from the other image. Illustrating by example, composite image 2103 includes the user (foreground of the at least one image 2101) and Buster's Chicken Stand (background of the at least one other image 2102). In another embodiment, the composite image 2104 includes the girlfriend (foreground of the at least one other image 2102) and the tree (background of the at least one image 2101).

In still another embodiment, the composite image 2104 includes elements of the foreground from both the at least one image 2101 and the at least one other image 2102, and the background of the at least one image 2101. Thus, in one embodiment the composite image 2105 includes the user and the girlfriend standing in front of the tree. The opposite fusion could occur as well, with the user and the girlfriend being depicted as standing in front of Buster's Chicken Stand in composite image 2106. Of course, a combination of these effects could be used to create a super-mash-up fusion image depicting the user and the girlfriend standing in front of both the tree and Buster's Chicken Shack. These combinations occurring in fusion images are illustrative only, as numerous others will be obvious to those of ordinary skill in the art having the benefit of this disclosure.

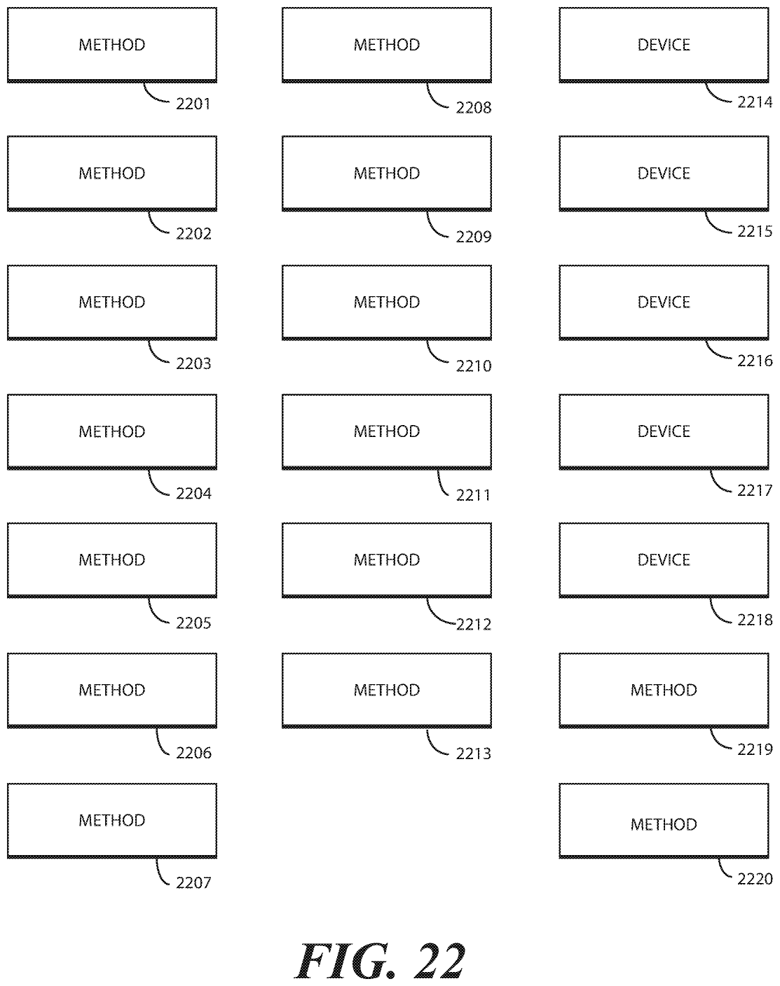

Turning now to FIG. 22, illustrated therein are various embodiments of the disclosure. The embodiments of FIG. 22 are shown as labeled boxes in FIG. 22 due to the fact that the individual components of these embodiments have been illustrated in detail in FIGS. 1-21, which precede FIG. 22. Accordingly, since these items have previously been illustrated and described, their repeated illustration is no longer essential for a proper understanding of these embodiments. Thus, the embodiments are shown as labeled boxes.

At 2201, a method in an electronic device comprises detecting, with one or more sensors, a geometry of a deformable electronic device having at least two imagers. At 2201, the method comprises capturing at least one image with at least one imager and at least one other image with at one other imager. At 2201, the method comprises processing, with one or more processors, the at least one image and the at least one other image as a function of the geometry of the deformable electronic device.

At 2202, the geometry of the deformable electronic device of 2201 defines a bend with the at least one imager situated on a first device housing portion positioned on a first side of the bend and the at least one other imager situated on a second device housing portion positioned on a second side of the bend. At 2203, the first device housing of 2202 abuts the second device housing portion such that a field of view of the at least one imager is oriented in a direction substantially opposite another field of view of the at least one other imager.

At 2204, the processing of 2203 comprises synthesizing the at least one image and the at least one other image into a panoramic image. At 2205, the processing of 2203 comprises superimposing at least a portion of the at least one image upon at least a portion of the at least one other image.

At 2206, the first device housing of 2202 is oriented substantially orthogonally with the second device housing portion such that a field of view of the at least one imager is oriented substantially orthogonally with another field of view of the at least one other imager. At 2207, the processing of 2206 comprises superimposing at least a portion of the at least one image upon at least a portion of the at least one other image.

At 2208, the first device housing of 2202 and the second device housing portion define a non-orthogonal angle with a field of view of the at least one imager and another field of view of the at least one other imager extending distally from the non-orthogonal angle. At 2209, the processing of 2208 comprises superimposing at least a portion of the at least one image upon at least a portion of the at least one other image.

At 2201, the geometry of the deformable electronic device of 2202 defines a plane with a field of view of the at least one imager oriented substantially parallel with another field of view of the at least one other imager. At 2211, the processing of 2210 comprises synthesizing the at least one image and the at least one other image to create a three-dimensional image.

At 2212, the processing of 2210 comprises synthesizing the at least one image and the at least one other image to create a depth map. At 2213, the processing of 2210 comprises synthesizing the at least one image and the at least one other image to create a stereo image.

At 2214, a deformable electronic device comprises one or more sensors detecting a geometry of the deformable electronic device. At 2214, the deformable electronic device comprises at least one imager, disposed to a first side of a deformable portion of the deformable portion of the deformable electronic device and capturing at least one image, and at least one other imager, disposed to a second side of the deformable portion of the deformable electronic device and capturing at least one other image. At 2214, one or more processors combine the at least one image and the at least one other image to create a composite image as a function of the geometry of the electronic deformable device.

At 2215, the geometry of 2214 is defined by a bend in the deformable portion. At 2215, the one or more processors combine the at least one image and the at least one other image by superimposing at least a portion of the at least one image upon at least a portion of the at least one other image.

At 2216, the composite image of 2215 is defined by a wider field of view than that of either the at least one image or the at least one other image. At 2217, an amount of the at least one image of 2215 superimposed upon the at least one other image is a function of an angle of the bend. At 2218, the composite image of 2214 comprises at least a semi-panoramic concatenation of the at least one image and the at least one other image.

At 2219, a method in an electronic device comprises detecting, with one or more sensors, a bending operation deforming the electronic device at a bend such that at least one imager is situated to one side of the bend and at least one other imager is situated to another side of the bend. At 2219, the method comprises capturing at least one image with the imager and at least one other image with the at least one other imager.

At 2219, the method comprises synthesizing the at least one image and the at least one other image as a function of an angle of the bend to create a composite image. At 2220, the field of view of the composite image of 2219 is greater than another field of view of the at least one image and the at least one other image.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
detecting, with one or more sensors, a geometry of a deformable electronic device having at least two imagers;
capturing at least one image with at least one imager and at least one other image with at least one other imager; and
processing, with one or more processors, the at least one image and the at least one other image as a function of the geometry of the deformable electronic device.

2. The method of claim 1, the geometry of the deformable electronic device defining a bend with the at least one imager situated on a first device housing portion positioned on a first side of the bend and the at least one other imager situated on a second device housing portion positioned on a second side of the bend.

3. The method of claim 2, the first device housing portion abutting the second device housing portion such that a field of view of the at least one imager is oriented in a direction substantially opposite another field of view of the at least one other imager.

4. The method of claim 3, the processing comprising synthesizing the at least one image and the at least one other image into a panoramic image.

5. The method of claim 3, the processing comprising superimposing at least a portion of the at least one image upon at least a portion of the at least one other image.

6. The method of claim 2, the first device housing portion oriented substantially orthogonally with the second device housing portion such that a field of view of the at least one imager is oriented substantially orthogonally with another field of view of the at least one other imager.

7. The method of claim 6, the processing comprising superimposing at least a portion of the at least one image upon at least a portion of the at least one other image.

8. The method of claim 2, the first device housing portion and the second device housing portion defining a non-orthogonal angle with a field of view of the at least one imager and another field of view of the at least one other imager extending distally from the non-orthogonal angle.

9. The method of claim 8, the processing comprising superimposing at least a portion of the at least one image upon at least a portion of the at least one other image.

10. The method of claim 2, the geometry of the deformable electronic device defining a plane with a field of view of the at least one imager oriented substantially parallel with another field of view of the at least one other imager.

11. The method of claim 10, the processing comprising synthesizing the at least one image and the at least one other image to create a three-dimensional image.

12. The method of claim 10, the processing comprising synthesizing the at least one image and the at least one other image to create a depth map.

13. The method of claim 10, the processing comprising synthesizing the at least one image and the at least one other image to create a stereo image.

14. A deformable electronic device, comprising:
one or more sensors detecting a geometry of the deformable electronic device;
at least one imager, disposed to a first side of a deformable portion of the deformable electronic device and capturing at least one image, and at least one other imager, disposed to a second side of the deformable portion of the deformable electronic device and capturing at least one other image; and
one or more processors combining the at least one image and the at least one other image to create a composite image as a function of the geometry of the deformable electronic device.

15. The deformable electronic device of claim 14, the geometry defined by a bend in the deformable portion, the one or more processors combining the at least one image and the at least one other image by superimposing at least a portion of the at least one image upon at least a portion of the at least one other image.

16. The deformable electronic device of claim 15, the composite image defined by a wider field of view than that of either the at least one image or the at least one other image.

17. The deformable electronic device of claim 15, wherein an amount of the at least one superimposed upon the at least one other image is a function of an angle of the bend.

18. The deformable electronic device of claim 14, further comprising a display, wherein both the at least one imager and the at least one other imager are situated beneath the display.

19. A method in an electronic device, the method comprising:
detecting, with one or more sensors, a bending operation deforming the electronic device at a bend such that at least one imager is situated to one side of the bend and at least one other imager is situated to another side of the bend;
capturing at least one image with the imager and at least one other image with the at least one other imager; and
synthesizing the at least one image and the at least one other image as a function of an angle of the bend to create a composite image.

20. The method of claim 19, wherein a field of view of the composite image is greater than another field of view of the at least one image and the at least one other image.
